(19) United States
(12) Patent Application Publication
(10) Pub. No.: US 2025/0209368 A1
(43) Pub. Date: Jun. 26, 2025

(54) METHODS, SYSTEMS AND KITS FOR QUANTUM-OPTIMIZED CROSS-BACKEND SOFTWARE DEVELOPMENT

(71) Applicant: ENTROPICA LABS, Singapore (SG)

(72) Inventors: Vishal SHARMA, Singapore (SG); Leonardo DISILVESTRO, Singapore (SG); Shahidee Bin Saharan NUR, Singapore (SG); Shao Hen CHIEW, Singapore (SG); Tommaso Federico DEMARIE, Singapore (SG); Ewan Franek MUNRO, Singapore (SG)

(21) Appl. No.: 18/851,972

(22) PCT Filed: Apr. 4, 2023
(86) PCT No.: PCT/SG2023/050226

§ 371 Date: Sep. 27, 2024

(30) Foreign Application Priority Data
Apr. 4, 2022 (SG) 10202203429U

(51) Int. Cl. G06N 10/80; G06N 10/20; G06N 10/60

(52) U.S. Cl. CPC G06N 10/80; G06N 10/20; G06N 10/60

(57) ABSTRACT

Methods, systems and kits for quantum-optimized cross-backend software development are provided. According to at least one aspect of the present embodiments, a method for building quantum optimization algorithms that can run on quantum hardware is provided. The method includes receiving an input comprising a user-defined problem and at least one pre-defined Variational Quantum Algorithm (VQA) statement and converting the received input into a workflow. The method also includes obtaining an abstract Variational Quantum Algorithm (VQA) representation based on the workflow and creating a compiled, target-optimized backend specific quantum circuit based on the abstract VQA representation and returning a structured, contextual and indexable output, wherein the output comprises an optimization result and additional metadata.

### PRIORITY CLAIM

This application claims priority from Singapore Patent Application No. 10202203429U filed on 4 Apr. 2022.

### TECHNICAL FIELD

The present invention generally relates to computer-implemented optimization, and more particularly relates to methods, systems and kits for quantum-optimized cross-backend software development.

### BACKGROUND OF THE DISCLOSURE

A digital or “classical computer” is a programmable device that processes bits of information according to logical rules. “Quantum computing” means the processing of information using quantum mechanical systems. A “quantum computer” can process quantum information and may solve some problems faster than conventional computers. In order to test the capabilities and advantages of a quantum computer in today's classical computing environment, it is possible to simulate the behavior of a quantum computer of limited size using a classical computer. The term “simulator” refers to a classical computer simulating a quantum computer.

Small-scale, prototypical quantum computers, referred to as Noisy Intermediate-Scale Quantum (NISQ) computers, are devices that can support tens to a few thousand noisy qubits, where a qubit is a two-level quantum system representing the fundamental unit of quantum information. Noisy in NISQ means the qubits are sensitive to errors caused by their interaction with the environment.

In addition to simulators, NISQ computers are also now available across a variety of modalities and supporting platforms such as ion traps, superconducting chips, photonics, and atom-based quantum computing systems accessible on the cloud via direct access or through commercial cloud providers such as AWS, Microsoft, Google, IBM). In addition, quantum hardware manufacturers (e.g. IonQ, Honeywell, Rigetti) are providing access to NISQ computers.

NISQ Algorithms (NISQAs) are heuristic methods that use NISQ devices while offloading. With fault tolerance still many years away, the quantum community is exploring what applications NISQAs can solve. More particularly, there is presently a growing interest in a family of NISQAs known as Variational Quantum Algorithms (VQAs). VQAs are a hybrid quantum-classical optimization algorithm in which an objective function (usually encoded by a parameterized quantum circuit) is evaluated by quantum computation, and the parameters of this function are updated using classical optimization methods. VQAs are the leading candidates for the demonstration that a quantum computer can solve a practical computing task better than a classical computer (given a reasonable resource metric); this demonstration is referred to as the Quantum Advantage.

So, there is growing interest in academia, industry, and the developer community to create and test VQAs for real-world applications, meaning that there is a growing need to make quantum computing software ready for applications with VQAs. Software supporting the development and deployment of quantum computations is now increasingly available (e.g., IBM Qiskit, AWS Braket, Google Cirq, Xanadu PennyLane) and many of these quantum computing softwares have libraries to facilitate the construction and deployment of quantum computations based on VQAs.

The objective is to use quantum computers to solve optimization problems. However, building quantum algorithms is difficult and challenging. It requires a deep knowledge of the underlying algorithms and a general understanding of quantum computing. The knowledge required is also likely to change at a different scale, suggesting that what works well on a ten qubit backend may not work equally well on a hundred qubits. This complexity hinders the accessibility of quantum computing to a large, non-specialist user base.

Even within the framework of VQAs, the extensive freedom of choice of constituent elements makes the complexity of algorithm creation soar with the size of the problem. Major challenges exist in areas such as in input definition (for example, one must cast instances of VQA problem statements in a binary formulation, yet there are no standardized methods) and output standardization (the lack of standardization of optimization problems and cross-backend standardized outputs amplifies the problem of generating and archiving quantum computations in a long-lasting and reliable manner), as well as in the area of composability and circuit definition (since VQAs are heuristic, there is little guidance on the optimal choices for VQA components).

Challenges also exist in VQA simplicity (binary inputs can be extensive and cumbersome to handle as data), scalability (the number of possible modifications and variations is generally extensive and larger quantum circuits may require picking the optimal elements from a large number of possible components), extensibility (extensions of established VQAs (like the Recursive “Quantum Approximate Optimization Algorithm” (QAOA) are typically more performant but more complex to implement programmatically than their basic counterparts), and customizability (a user may have a proprietary component they wish to use in a VQA yet, currently, it is hard to add custom components into quantum workflows built with existing software libraries).

Finally, there are issues and challenges in quantum computing financial costs and VQA integration. As to costs, running computations on quantum hardware is expensive and time-consuming. Budgeting is a practical concern, exacerbated by the lack of automated methods to estimate the financial costs of running quantum computations. As to integration, the classical-quantum loop scales differently for both the size of the quantum processing unit (QPU) and its underlying technology. A generic VQA run requires exchanging information between quantum computers and classical computers. Without optimizing the interplay of the two computing units, the VQA run may suffer from network issues (like lost connectivity) and latency delays.

In the quest for quantum advantage, one needs better methods to create accessible and scalable VQA workflows. Thus, there is a need to provide methods, systems and kits for quantum-optimized cross-backend software development which address the drawbacks and challenges presently existing. In addition, there is a critical need for high-level software libraries and toolboxes to construct, optimize and test VQAs and other quantum algorithms such as Fault-tolerant Quantum Algorithms (FTQAs) on NISQ devices. Furthermore, other desirable features will become apparent from the subsequent detailed description and the appended claims, taken in conjunction with the accompanying drawings and this background of the disclosure.

### SUMMARY

According to at least one aspect of the present embodiments, a method for building quantum optimization algorithms that can run on quantum hardware is provided. The method includes receiving an input comprising a user-defined problem and at least one pre-defined Variational Quantum Algorithm (VQA) statement and converting the received input into a workflow. The method also includes obtaining an abstract Variational Quantum Algorithm (VQA) representation based on the workflow and creating a backend specific quantum circuit based on the abstract VQA representation and returning an output, wherein the output comprises an optimization result and additional metadata.

According to another aspect of the present embodiments, a system for building quantum optimization algorithms is provided. The system includes an input module and a workflow module. The input module obtains an input model, where the input model includes a standardized version of a user-defined problem and at least one pre-defined Variational Quantum Algorithm (VQA) statement. The workflow module takes as input the input model and is configured to convert the input model into a sequence of operations defining a workflow, to obtain an abstract Variational Quantum Algorithm (VQA) representation based on the workflow, and set up and run a classical-quantum loop. The classical-quantum loop is configured to create and execute the explicit representation of the quantum circuit based on the abstract VQA representation, optimize the parameterized variables of such a circuit, interrupt the loop once a satisfying training condition has been met, and return an output comprising an optimization result and metadata

According to another aspect of the present embodiments, a set of tools designed to improve the usability and performances of building quantum optimization algorithms is provided. The tools include a cost management tool to estimate costs associated with a given quantum computation wherein costs include financial costs, execution time and other metrics associated with running the given quantum computation, and AutoVQA, a system that takes the user-defined problem associated with the given quantum computation and evaluates the optimal choices of parameters for a Variational Quantum Algorithm statement of the user-defined problem. The tools also include a qubit routing tool to compile the Variational Quantum Algorithm representation in a backend-explicit optimized quantum circuit.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to illustrate various embodiments and to explain various principles and advantages in accordance with present embodiments.

FIG. 1 depicts a schematic illustration of functional elements and the application programming interface (API) structure for a system for constructing and executing Quantum Approximate Optimization Algorithm (QAOA) workflows (referred hereinafter as “OpenQAOA”) in accordance with present embodiments.

FIG. 2 depicts an illustration of an anatomy of a workflow result for the Results Object of the OpenQAOA Core in accordance with the present embodiments.

FIG. 3 depicts a block diagram of operation of the Resource Estimator and Profiling Module enabler of the OpenQAOA in accordance with present embodiments.

FIG. 4 depicts a block diagram of operation of the Benchmarking Module enabler of the OpenQAOA in accordance with present embodiments.

FIG. 5 depicts an illustrative representation of a generic OpenQAOA Workflow in accordance with the present embodiments.

And FIGS. 6A, 6B, 6C and 6D depict an illustration of a more detailed presentation of a generic OpenQAOA Workflow in accordance with the present embodiments.

Skilled artisans will appreciate that elements in the figures are illustrated for simplicity and clarity and have not necessarily been depicted in full detail.

### DETAILED DESCRIPTION

The following detailed description is merely exemplary in nature and is not intended to limit the invention or the application and uses of the invention. Furthermore, there is no intention to be bound by any theory presented in the preceding background of the invention or the following detailed description. It is the intent of present embodiments to provide methods, systems and kits for constructing and executing Quantum Approximate Optimization Algorithm (QAOA) workflows, independent of its implementation in any language. Thus, in accordance with present embodiments, a cross-backend Software Development Kit (SDK) for quantum optimization called OpenQAOA is proposed. The SDK is a modular library to build custom quantum algorithms for applications in optimization. The SDK facilitates the construction and deployment of Variational Quantum Algorithm (VQA) workflows on multiple quantum computing systems or simulators by providing an Application Programming Interface (API) to build and run quantum algorithms on multiple backends. The SDK creates algorithms that can ideally run on any qubit-based, universal quantum computing architecture. Advantageously, the user does not need extensive knowledge of quantum computing architectures or quantum algorithms.

VQAs leverage the toolbox of classical optimization, which is the mathematical problem of selecting the values of a set of variables to minimize an objective function. VQAs include parametrized quantum circuits, i.e., quantum circuits that depend on classical parameters, that run on NISQ computers while outsourcing the parameter optimization to a classical optimizer. The general framework for VQAs includes three basic sets of elements. These are input to the VQA, a classical-quantum loop, and output of the VQA. The input to the VQA can be a problem statement, a quantum ansatz (i.e., a variational quantum circuit dependent on some parameters θ), a parametrized cost function that measures the solution quality, or any additional set of training data that the optimization routine can use. Crucially, the quantum circuit must also be compiled for execution on the desired target quantum computer. The Classical-Quantum Loop (CQL) is an estimation routine to compute the cost function via measurements on the quantum computer (or on a simulator) and, more particularly, may include an optimization routine to update the parameters θ to minimize the value of the cost function. The output of the VQA can be a set of parameters that, in the optimal case, minimizes the cost function, a mapping from the minimized cost function to the solution of the problem, or all the metadata describing the classical-quantum loop.

There is growing interest in using VQAs to solve classical problems in applied mathematics. Consider combinatorial optimization problems: They are ubiquitous in industry and suffer from poor scaling with the system size. These problems are intrinsic ‘search problems’ and therefore, they may benefit in the fault-tolerant regime from the quadratic speedup of Grover's Algorithm. At the same time, circumstantial evidence suggests that applying VQAs, such as the Quantum Approximate Optimization Algorithm (QAOA), to classical optimization problems might lead to quantum advantage on NISQ devices.

OpenQAOA is a scalable and efficient optimization-specific SDK that offers features not available from present solutions. OpenQAOA is cross-platform, offers numerous parametrizations and parameter initialization strategies, the ability to prepend an initial state to the computation or append a state after the VQA has completed, automatic and manual circuit construction (utilizing built-in workflows and workflows factory), built-in circuit compilation module, VQA heuristics, resource estimation and profiling, benchmarking module, Error Mitigation Module, Noisy simulators, automatic VQA construction via AutoVQA, and a series of GUIs to enable visualization of circuits and results. In addition, the functional (modular) design of OpenQAOA allows users to replace components by simply preserving the I/O relationships. Effectively, OpenQAOA provides an API to construct quantum optimization workflows.

Two key advantages afforded by OpenQAOA in comparison to existing solutions for constructing and executing QAOA computations are scalability (referring to the ability to execute large QAOA computations while minimizing the resource footprint across all aspects of the workflow) and efficiency (referring to the workflows and feature sets of OpenQAOA support maximum user productivity thereby allowing goals to be achieved conveniently and quickly). There is a close connection between scalability and efficiency in the context of QAOA, but they also have some independence. For instance, even for small QAOA experiments (where scale is not an issue) there can be significant advantageous productivity gains to be made with predefined problem classes, meaningfully and manageably formatted results, a set of good pre-defined algorithmic settings, a curated collection of benchmark computations, and “press play”-type options.

The pre-defined problem classes allow the user to easily specify their optimization problem without the burden of knowing or providing its QUBO formulation. Results are advantageously returned in a meaningful and manageable format to the user, meaning that the data is advantageously readily labelled so the user understand what the data is, and the data is efficiently formatted and labelled so that it is not unduly large in size.

A set of effective pre-defined algorithmic settings helps users obtain effective results quickly and with minimum effort. For instance, the default algorithmic settings are ones that are known to perform well. In addition, OpenQAOA provides fast and diverse methods to classically simulate the QAOA under different conditions, where diversity in this context refers to the ability to simulate both noiseless and noisy computations with a simple input syntax for specifying desired conditions. The curated collection of benchmark computations advantageously enable assessment of the performance of the QAOA by facilitating comparisons with alternative algorithmic approaches and, when executed on real quantum computers, allow useful information to be deduced about the noise characteristics of the device. Finally, the “press play”-type options enable multiple QAOA computations such as comparing different algorithmic settings to be constructed and launched easily.

When one is working with larger QAOA computations on real quantum computers, all of the basic functionalities and components such as the circuit construction methods and the results object must remain efficient. However, additional complexities such as circuit compilation and error mitigation become crucial to achieving the best performance from QAOA at large scales.

Of course, circuit compilation methods—qubit selection, qubit mapping, and qubit routing—must still be performed in order to run even a small QAOA circuit on a real quantum processing unit (QPU). At small scales the quality of the final computational results will be less affected by choosing one qubit routing schedule over another, however at large scales this is not the case. For example, at larger scales it becomes vital to find good qubit routing schedules, not just any qubit routing schedule.

### Definitions

In order to better understand the present embodiments disclosed herein, it is necessary to define several terms.

The “qubit” is a two-level quantum system representing the fundamental unit of quantum information.

A “gate-based quantum computer” is a quantum computing device that transforms input data according to a sequence of qubit initializations, unitary operations specified as a sequence of gate operations, and a series of qubit measurements.

The sequence of actions including qubit initializations, gate operations, and qubit measurements are defined as a “quantum circuit”. Simply stated, a quantum circuit is a universal model representing quantum computations as a sequence of initialization, quantum gates and measurements performed on qubits. A “quantum gate” is a logical operation that acts on an arbitrary number of qubits. A “quantum algorithm” is a sequence of instructions, including classical processes and quantum circuit(s). And a “workflow” is the practical embodiment of an algorithm; a workflow corresponds to a series of actual, practical operations that implement an algorithm's abstract steps.

“Noisy Intermediate-Scale Quantum (NISQ) computers” are devices that can support tens to a few thousand noisy qubits. Noisy means the qubits are sensitive to errors caused by their interaction with the environment. “NISQ Algorithms (NISQAs)” are heuristic methods that use NISQ devices while offloading part of the computation to classical computers. Companies use NISQ algorithms to perform applied research and identify use cases that could benefit from quantum computation. Current state-of-the-art NISQ devices are already demonstrating instances of “Quantum Supremacy”: quantum computers outperforming the best classical supercomputer for specific contrived mathematical tasks.

“Fault-tolerant Quantum Algorithms (FTQAs)” require large scale quantum computers to support active error correction for noise suppression. Theoretical analysis shows that FTQAs can achieve polynomial and, in some cases, exponential speedups over classical computers for some practical problems.

A “Software Development Kit (SDK)” is a collection of software development tools in one installable package. The role of an SDK is to allow users to create software applications.

An SDK can take the form of “Application Programming Interfaces (APIs)”. An API is a software interface that offers a service to another piece of software. APIs allow communication between applications. A document or standard that describes how to build or use such an interface is called an API specification. An API can be made up of parts that act as tools or services available to the programmer. A program or a programmer that uses one of these parts calls that API portion. The calls that make up the API are also known as “subroutines”, “methods”, “requests”, or “endpoints”.

“Open Quantum Assembly Language (OpenQASM)” is an imperative programming language for describing quantum circuits designed to serve as an “Intermediate Representation (IR)” for quantum instructions. An intermediate representation is the data structure or code used internally by a compiler or virtual machine to represent source code. An IR is designed to be conducive for further processing, such as optimization and translation. OpenQASM is capable of describing universal quantum computing.

“Quil” is a quantum “Instruction Set Architecture (ISA)” provided by Quantum Computing of Berkeley, California USA. A quantum ISA is an abstract model of a quantum computer which dictates what instructions are physically allowed on the actual hardware.

A “backend” in the context of the following description of preferred embodiments is a device where one can run a quantum algorithm. Backends can be QPUs accessible through the internet (cloud-access) from hardware providers or can be a simulator which can be accessed either over the internet or exist on a local machine.

A “quantum hardware provider” is an entity (usually, but not limited to, commercial) building or servicing QPUs over the internet. All available QPUs are accessible through their external APIs. Examples of such providers are IBM (serviced through IMB Q), Rigetti (serviced through Quantum Cloud Services (QCS)), Amazon Web Services (AWS), Google Cloud Platform (GCP) and Microsoft's Azure (MA)), and IONQ (serviced through AWS, MA, and, GCP). The term “quantum cloud” is used to describe a generic ensemble of such quantum cloud services.

“Qiskit” is a Python open-source SDK for working with OpenQASM and the IBM Q quantum processors.

“PyQuil” is a Python library for quantum programming using Quil, the quantum instruction language developed at Rigetti Computing.

“Braket” Python SDK is an open-source library providing a framework to interact with quantum computing hardware devices through AWS.

### Problem Statement

While the objective in present quantum computing research in academia, industry, and the developer community is to use quantum computers to solve optimization problems, multiple problems interfere with this task. First, building quantum algorithms is hard in general as it requires a deep knowledge of the underlying algorithms and a general understanding of quantum computing at the hardware and logical level. The knowledge required is also likely to change at a different scale, suggesting that what works well on a ten qubit backend may not work equally well on one hundred qubits. This complexity hinders the accessibility of quantum computing to a large, non-specialist user base. Note that the complexity refers to both NISQAs and FTQAs.

In regards to VQAs, one can represent a VQA as a finite sequence of actions and constituents. The input to the VQA includes the mathematical representation of the problem instance to solve together with the formal definition of the meta parameters that define the VQA. These meta parameters may consist of the number of qubits, the choice of the parameterized circuit (i.e., the ansatz and corresponding quantum gates), the backend properties, and the definition of the classical-quantum loop. To run the same VQA across different backends, one may want to adopt a uniform, abstract representation that can be understood and executed by any generic quantum computing system.

In addition, non-trivial aspects of these implementations may depend on the specific quantum backend. Moving across different backends may require not only substantial changes in the overall logic of the circuit construction (for example, certain backends may favor specific quantum gates or may only support a subset of native quantum gates) but also changing the underlying quantum instruction language (for example, IBM uses OpenQASM, while Rigetti uses Quil). Furthermore, specific hardware-dependent compilation steps (such as qubit selection, mapping, and routing) will be required prior to executing the circuit on a quantum computer. Consequently, the end-user may need to rewrite large parts of the code multiple times, making this process time-consuming and prone to coding bugs and errors.

Hence, the second problem is that even within the framework of VQAs, the extensive freedom of choice of constituent elements makes the complexity of algorithm creation soar with the size of the problem highlighting the following significant issues. First, there is the issue with input definition. In general, instances of problem statements that VQA can solve must be cast in a binary formulation, and there are no standardized methods for it. Next, there is a lack of simplicity in that binary inputs can be huge and cumbersome to handle as data. Further, there is no output standardization. The lack of standardization of optimization problems and cross-backend standardized outputs amplifies the problem of generating and archiving quantum computations in a long-lasting and reliable manner.

Problems are also presented in terms of composability and circuit definition. Since VQAs are heuristic, there is little guidance on the optimal choices for their components. Furthermore, these choices may profoundly affect the performance of the algorithm. Thus, there is a need for an integrated code-base where users can bring all the pieces of a VQA together. This problem leads to issues with scalability and extensibility. Since the number of possible modifications and variations is extensive, larger quantum circuits may result in challenges to pick optimal elements from a large number of possible components. Likewise, extensions of established VQAs (like the Recursive QAOA) are generally more performant and more complex to implement programmatically than their essential counterparts, so picking the right elements is key to success.

Customizability presents a challenge as a user may have a proprietary component they wish to use in a VQA, yet, currently, it is hard to add custom components into quantum workflows built with existing software libraries. In addition, running computations on quantum hardware is expensive and time-consuming leading to problems with high financial costs. Budgeting is a practical concern, exacerbated by the lack of automated methods to estimate the financial costs of running quantum computations. Finally, the classical-quantum loop scales differently for both the size of the QPU and its underlying technology. A generic VQA run requires exchanging information between quantum and classical computers. Thus, without optimizing the interplay of the two computing units, the VQA run may suffer from network issues (like lost connectivity) and latency delays leading to integration problems.

Therefore, in the quest for quantum advantage, one needs better methods to create accessible and scalable VQA workflows. Thus, there is a critical necessity for high-level software libraries and toolboxes to construct, optimize and test VQAs on NISQ devices. However, these problems are not unique to VQAs, but also apply to algorithms such as FTQAs.

### Solutions

In accordance with the present embodiments, a cross-backend Software Development Kit (SDK) for quantum optimization is proposed. An exemplary SDK in accordance with the present embodiments is a modular library to build custom quantum algorithms for optimization problems. The SDK provides composability, simplicity, efficiency, and scalability and addresses all the issues and problems discussed hereinabove.

The SDK in accordance with the present embodiments assists the user with the input description, while providing a cross-backend standardized output for optimization problems. In addition, the SDK in accordance with the present embodiments includes an API, which contains built-in workflows and a workflow factory designed to help novice and experienced users compose complex quantum algorithms for optimization. Further, the SDK in accordance with the present embodiments permits users to enhance the core algorithmic features of the SDK with an extensive set of Enablers aimed at providing efficiency and scalability, including: a problem class module to facilitate the creation of inputs; a benchmarking module to assess algorithm and device performance; a circuit compilation module to minimise the resources required to execute a QAOA circuit; a resource estimation and profiling module to assist the user in evaluating the resources required to meet their objectives; an error mitigation module to suppress noise on the device and improve the quality of the solution; and the AutoVQA module to design general VQAs. Further, through its Graphical API the SDK in accordance with the present embodiments permits users to visualize data pertaining to the construction, execution, and results of the quantum computation of interest. Finally, the SDK in accordance with the present embodiments is backend-agnostic and can integrate with several existing quantum computing systems. In plain language, the SDK in accordance with the present embodiments exposes to the end-user a set of APIs to create and run quantum algorithms on multiple backends to solve optimization problems.

The SDK in accordance with the present embodiments enables users to compose quantum optimization algorithms/workflows. The word compose has a precise meaning. Quantum algorithms (such as QAOA) are a sequence of instructions over a set of specific classical and quantum components. One can think of these components as processes detached from any specific technical implementation and can view them in light of their functional properties as abstract entities. For example, consider the classical optimizer used in the Classical-Quantum Loop (CQL) of a VQA: its abstract representation is a function taking as input a parameterized cost function and a set of parameters and outputs a new set of parameters with the target of reducing the cost function. Given the abstraction, it becomes irrelevant whether one uses a local optimizer like Cobyla or a neural network trained on proprietary data.

In this sense, composability defines the SDK's ability in accordance with the present embodiments to provide a procedural and straightforward way to construct complex quantum optimization workflows starting from abstract definitions of the classical and quantum components. From a programming viewpoint, these complex workflows can be considered as an API. A crucial aspect of this design choice is that the end-user can add and swap components as long as they satisfy the functional properties specified by the SDK.

The SDK in accordance with the present embodiments abstracts the complexity of quantum optimization algorithms by providing users with two strategies: (a) A set of Built-In Workflows and a Workflow Factory (the “Factory”) to help assemble a workflow from scratch. The Factory allows users to access the source code to compose new workflows. This framework allows inexperienced users utilizing the SDK in accordance with the present embodiments to run a QAOA algorithm through the SDK via the built-in workflows by only providing the mathematical description of the problem to solve. The mathematical description, of course, has to be cast in a binary format and the SDK in accordance with the present embodiments simplifies this task by offering tools to cast problems into binary problems suitable for a quantum computer. Once the mathematical statement is ready, the SDK can automatically run the built-in QAOA workflows in accordance with the present embodiments using default settings, thereby removing the burden of any prior knowledge of quantum algorithms or the physics of the quantum backends. The user can also opt-out of the default settings and modify the built-in workflows as specified in the API documents. For example, the user could change the classical optimizer in the classical-quantum loop simply by updating the method variable in the workflow.

The built-in workflows of the SDK in accordance with the present embodiments also include extensions of basic VQAs. Users may directly call built-in entry points that identify these extensions. In addition, all built-in algorithms are fully customizable: components can be swapped and enhanced as desired by the end-user.

To summarize, the SDK in accordance with the present embodiments advantageously addresses the existing problems of modularity and customizability, scalability and simplicity. In regards to modularity and customizability, each part of a quantum algorithm can be replaced, modified and customized in accordance with the present embodiments. If a user has a custom optimizer, the user can add it to the algorithm in the Factory. In regards to scalability, the same structure can be used on circuits consisting of thousands of qubits, while tools provided by the SDK such as circuit compilation and error mitigation aim to address performance issues related to noise proliferation in large QAOA computations. In regards to simplicity, the SDK in accordance with the present embodiments advantageously enables users without extensive experience in quantum computing to build and create quantum optimization algorithms that run on quantum computing systems of diverse architectures.

In addition, the SDK in accordance with the present embodiments is, as discussed hereinabove, backend agnostic. The SDK is designed to assist the end-user with the creation and execution of modular optimization algorithms on quantum hardware and classical simulators advantageously enabling the exact computation to be able to run over different quantum computers by changing only a few lines of code.

Turning to the methods, systems and kits for constructing and executing QAOA workflows in accordance with the present embodiments (i.e., OpenQAOA), the fundamental purpose of OpenQAOA is that it is designed to enhance QAOA research and the execution of QAOA computations. The key advantages of OpenQAOA in accordance with the present embodiments over present methods, systems and kits is its efficiency, scalability, reproducibility and consistency, correctness and error reduction, algorithmic flexibility, resource management and estimation, and visualization. The key features of OpenQAOA in accordance with the present embodiments are automatic translation of an input statement into binary form; an API that allows creation of quantum optimization workflows; built-in implementations of a range of VQAs including QAOA, R-QAOA and G-QAOA; extended options of circuit ansatz, parameter initialization, and classical optimizers; creation of arbitrary VQAs through the workflow factory; an ability to append or prepend quantum states; multi backend support; and a set of stand-alone tools such as those within the OpenQAOA Enabler 150 and the OpenQAOA GUI 185. The extended options of circuit ansatz, parameter initialization, and classical optimizers include multiple circuit ansatz; extended, standard, and annealing parametrization strategies, and original and Fourier types; linear, random, and custom initialization strategies; and classical optimizers including SciPy suite, Scikit-quant, custom gradient methods, and machine learning methods. The multi backend support includes support of QPUs such as IBM Q, Rigetti, and IONQ and support of simulators such as Vectorized (by Entropica Labs of Singapore) and Qiskit (by IBM of Armonk, New York, USA).

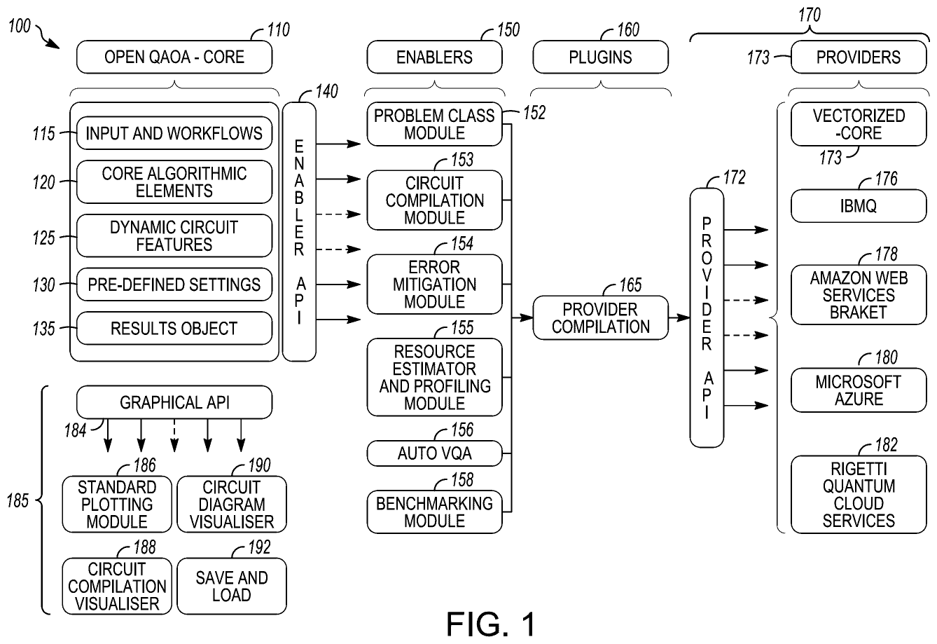

Referring to FIG. 1, a schematic illustration 100 depicts functional elements and the application programming interface (API) structure for a system OpenQAOA for constructing and executing QAOA workflows in accordance with present embodiments. The main components of OpenQAOA belong to one of four categories: the OpenQAOA Core 110, the OpenQAOA Enabler 150, the OpenQAOA Backends 170 and the OpenQAOA Graphical User interface (GUI) 185. The OpenQAOA Core 110 contains the basic elements necessary to manage user input, construct circuits and dispatch them to backends for execution, and return results. The OpenQAOA Enabler 150 contains additional modules to enhance multiple aspects of the QAOA practitioner's workflow tasks, as well as to improve the performance of the algorithms being executed. The OpenQAOA Backends 170 are the set of devices (real quantum computers or simulators) on which computations are executed. And the OpenQAOA GUI 185 is a visualization tool. Visualization is a powerful and invaluable element in analysing aspects of any algorithm and its performance, and QAOA is no exception. The OpenQAOA GUI 185 allows for the visualisation of data produced at all stages of a workflow in OpenQAOA.

The Open QAOA Core 110 includes functions such as Input and Workflow creation 115, core algorithm elements 120, dynamic circuit features 125, pre-defined settings 130 and results object 135. The OpenQAOA Core 110 is connected to the OpenQAOA Enabler 150 via an Enabler API 140. The abstract character of the OpenQAOA Enabler 150 enables it to create a point of contact between the OpenQAOA Core 110 and various plugins 160.

The OpenQAOA Enabler 150 includes a problem class module 152, a circuit compilation module 153, an error mitigation module 154, a resource estimator and profiling module 155, the AutoVQA 156 and the benchmarking module 158.

The plugins 160 are provider-dependent, provide provider-compilation 165 and are responsible for providing the quantum circuit for execution at one or more of the providers at the OpenQAOA Backends 170. The provider-compilation accesses the providers 173 via a provider API 172, the providers 173 being any one or more of a vectorized-core 174, IBM Q 176, AWS Braket 178, Microsoft Azure 180, and Rigetti quantum cloud services.

The OpenQAOA GUI 185 is connected to the OpenQAOA Core 110 via a graphical API 184 and includes a standard plotting module 186, a circuit compilation visualizer 188, a circuit diagram visualizer 190, and save and load functions 192.

Given the importance of effective circuit compilation for executing QAOA on QPUs, OpenQAOA is explicitly designed with qubit selection, qubit mapping, and qubit routing in mind. OpenQAOA provides an interface allowing specialized compilation modules to be called and sends these compilation modules information on the optimization problem and the QPU to be used. OpenQAOA receives a specification of which physical qubits on the device to use (‘qubit selection’) and an initial mapping of the logical qubits (those in the abstract description of the circuit to be implemented) and the selected physical qubits (‘qubit mapping’). A schedule for inserting additional operations, including but not limited to SWAP gates, that compensate for the limited device connectivity are also received and allow the target computation to be performed (‘qubit routing’). OpenQAOA uses these solutions to construct a circuit that can be deployed to the specified QPU as part of the QAOA workflow.

All the aforementioned steps have an explicit dependency on the device where the computation is to be executed. However, there is little hope for scalability and efficiency if these steps must be rewritten from scratch for each quantum processing unit, as this would lead to code inefficiency and code maintainability issues. OpenQAOA overcomes this limitation by operating all these passes at the level of the OpenQAOA abstract circuit. The abstract circuit is an OpenQAOA representation of the whole algorithm which is entirely independent of the actual device that is to be used for the computation. This doesn't mean that peculiarities of a given device are discarded, but, on the contrary, it simply means that all devices are treated equally and therefore compilation passes can be executed in a device-agnostic fashion.

OpenQAOA also consists of a number of methods to simulate QAOA circuits, both noiseless and noisy. For noiseless QAOA circuits, statevector or wavefunction simulators, which mimic the behavior of a noiseless quantum computer, return a full output wavefunction. Such simulators include OpenQAOA's own vectorized simulator as well as simulators provided in other open-source quantum computing libraries.

Specialized simulators for computing specific properties of the output of a QAOA circuit, which are based on explicit mathematical formulae derived from analytic analysis. As an example, for single-layer QAOA it is possible to obtain explicit mathematical expressions for important quantities such as expectation values or correlation functions. Typically, this allows one to study problems of a larger size than would be the case with a conventional statevector computation. This simulator is referred to as a “single-layer simulator” (SLS).

For noisy QAOA circuits, several simulators are provided. A full quantum master equation (ME) simulator solves for a time evolution of a density matrix of qubits being used for computation in the presence of specifiable noise processes. A quantum Monte Carlo wavefunction (MCWF) simulator, which simulates individual ‘trajectories’ of a system in a stochastic manner is also provided. The memory footprint of the MCWF simulator approach is significantly lower than that of the ME simulator because an approximation of the density matrix may be obtained by averaging over multiple trajectories; in addition, the individual trajectories can be used to investigate the effect of faults in a single experimental shot (such information is washed out in the ME approach). A deterministic error wavefunction (DEWF) simulator allows the placement of specific errors at predetermined locations in the circuit. The DEWF differs from the MCWF simulator because errors in the MCWF occur stochastically in space (i.e., on which qubit(s)) and in time (i.e., at which moment in the circuit). An effective error (EE) simulator computes the effective error at the circuit output resulting from user-specified error(s) of any type at any location in the QAOA circuit.

Note that the simulation of quantum circuits consisting of discrete operations as an equivalent time evolution problem (as is the case in the ME and MCWF simulators) requires a careful specification of the correspondence between the underlying gate set (the discrete operations theoretically realizable on the quantum computer) and the Hamiltonian(s) generating the time evolution. Noise processes supported include, but are not limited to: a) state preparation and measurement (SPAM) noise, b) dephasing, c) depolarizing, d) amplitude damping, and e) cross-talk errors, such as residual ZZ interactions in certain types of superconducting qubits.

The noisy simulation module in accordance with the present embodiments is a bridge between the world of noiseless simulations and the world of real QPU computations and can advantageously be used with the same underlying syntax in OpenQAOA (with or without additional input from the user to specify desired noise characteristics).

In accordance with the present embodiments, a ‘press play’ feature is provided which is derived from the basic OpenQAOA Workflow. For a given input problem, the ‘press play’ feature provides the user with a simplified syntax to specify multiple conditions under which the QAOA (or its variants, such as R-QAOA) should be executed. Such conditions can include algorithmic settings such as the number of QAOA layers, the classical optimiser, and the parametrisation; and device settings such as where the computations should be executed (e.g., on a noisy simulator, a wavefunction simulator, or a QPU). For example, the following Python pseudocode illustrates how the ‘press play’ feature may be invoked for a travelling salesperson problem:

# Define TSP instance
tsp = ...
# Set up Press Play object
play_tsp = press_play(tsp)
# Specify conditions
devices = # list of devices
optimizers = # list of optimizers
parametrizations = # list of parametrizations
# Execute
play_tsp.play([devices, optimizers, parametrizations])

The ‘press play’ feature provides the user with a simple interface to launch multiple QAOA experiments with a minimum of coding effort. The user need not undertake the tedious task of preparing many individual computations, resulting in a greater degree of workflow effciency.

‘Dynamic circuit features’ refers to the ability to use mid-circuit measurements and feed-forward logic in the QAOA circuit and is advantageously provided in OpenQAOA in accordance with the present embodiments. ‘Dynamic circuit features’ mean that the quantum circuit can be modinied on the fly, during its execution, depending on the outcome of measurements made upon it. Such ‘dynamic circuit features’ may be particularly helpful in QAOA workflows in situations such as the following illustrative settings: a) reducing the number of qubits needed to execute a problem; b) mixer operators that ensure the exploration of the solution space are confined to a desired subspace, such as feasible solutions or solutions with some specific property or characteristic; or c) error detection, allowing experiments where an error known to have occurred is to be discarded from the results. The main advantage conferred by the availability of ‘dynamic circuit features’ in OpenQAOA is algorithmic flexibility. Users of OpenQAOA advantageously have more tools at their disposal to tackle problems with QAOA which can moreover be used simply, efficiently, and reliably.

The Enabler Interface (EI) is responsible for communication between the OpenQAOA Core 110 and the OpenQAOA Enabler 150. The EI performs two basic tasks: a) it prepares and sends the necessary information to modules within the OpenQAOA Enabler 150, and b) it receives information from the OpenQAOA Enabler 150 and dispatches it to components of the OpenQAOA Core 110. The EI comprises multiple interfaces, each responsible for communicating with a module or component of the OpenQAOA Enabler 150. Thus, the EI can be viewed as a collection of interfaces: a Circuit Compilation Interface for interfacing with the circuit compilation module 153, an Error Mitigation Interface for interfacing with the error mitigation module 154, and so on.

As an example of EI, the Circuit Compilation Interface is discussed hereafter. The OpenQAOA Core 110 is designed to work in conjunction with modules that perform circuit compilation (i.e., the circuit compilation module 153). Given the standard OpenQAOA input data (data specifying the problem instance, together with any desired algorithmic settings) as well as the name of target quantum computer (i.e., a specific device such as the Rigetti Aspen-M3), the OpenQAOA Core 110 passes relevant information to the Circuit Compilation Module (CCM) 153. The CCM performs tasks including qubit selection, qubit mapping, qubit routing, and any necessary post-processing of the outcome of these steps. This results in a circuit with the necessary additional operations (e.g., SWAP operations, in the case of superconducting quantum computers) allowing the circuit to be executed on the target device.

The circuit compilation process can result in a permutation of the original qubit labels. For example, while the qubits may remain physically unmoved, qubit routing can modify their logical index in the circuit description. This means that the QAOA circuit must be constructed carefully, to ensure that the variational parameters are passed to the correct gate operations as intended and that measurements are performed on the correct set of qubits. In accordance with the present embodiments, OpenQAOA automatically manages all of these details, removing a significant burden from the user.

The set of methods and functions within the OpenQAOA Core 110 that deal with circuit compilation, referred to as the Circuit Compilation Interface (CCI) is responsible for: a) preparing and dispatching all necessary information on the problem and the target device to the CCM 153, and b) retrieving the solution from the CCM 153 and managing the details of measurements, parameter-to-gate assignments, and any similar necessary tasks during execution of the QAOA computation. The CCI confers workflow efficiency benefits since otherwise a significant amount of tedious and error-prone work would need to be carried out by the user. Moreover, when used in conjunction with the CCM 153, the CCI tackles one of the main scalability issues with QAOA, namely that of effectively executing arbitrary QAOA computations on devices with a limited qubit connectivity.

Across the QAOA family of algorithms there is a wide range of associated algorithmic settings, or hyperparameters, which the user must provide to fully specify the computation to be executed. Examples include the number of QAOA layers, the initial values for the variational parameters, the parametrisation (i.e., any relations that must be preserved between variational parameters in the circuit), and the classical optimiser to be used (which itself can have its own hyperparameters to be chosen). Users face a significant challenge when confronted with the need to commit to specific choices for all of these algorithmic settings as it can be far from obvious which hyperparameter settings will be most effective, a problem which is compounded by the diversity of problems one may wish to solve and the fact that combinations of hyperparameters can interact in non-trivial ways.

There are two approaches to confronting this difficulty. The first approach is to exploit knowledge and experience built up through previous experimentation. An example is the ramp initialisation for the QAOA variational parameters where the initial values of these parameters are set by analogy to a quantum annealing schedule that is characterised by a linear function. Empirical evidence suggests this approach outperforms, on average, an approach where the QAOA parameters are given random initial values. The second approach is to exploit analytically provable features of QAOA. An example of this is the phenomenon of parameter ‘concentration’, where the optimal parameters for problem instances within a specific class can be shown to concentrate on certain values. Having solved one problem in the class, the optimal parameters obtained can then be used as a good initialisation for a different problem instance drawn from the same class.

In accordance with the present embodiments, OpenQAOA's Pre-defined Settings 130 are a collection of specifiable default values and choices for the many hyperparameters of QAOA workflows, and are drawn from the aforementioned two approaches. The Pre-defined Settings 130 confer workflow efficiency by removing the time-consuming burden of selecting hyperparameters, and providing settings that have been validated in some respect to deliver better quality solutions than an otherwise random choice of settings.

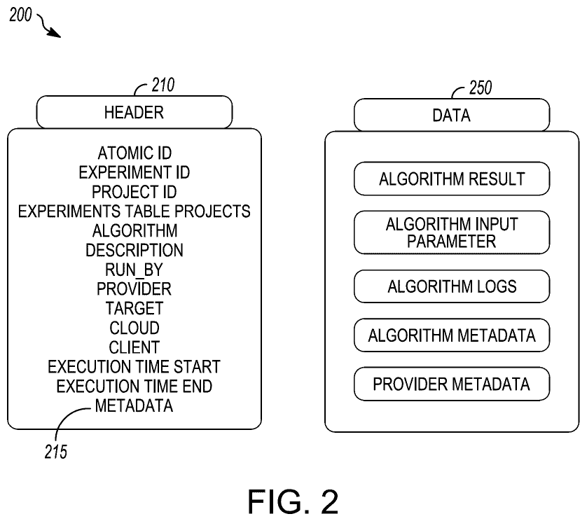

Referring to FIG. 2 an illustration 200 depicts an anatomy of a workflow result for the Results Object 135 of the OpenQAOA Core 110 in accordance with the present embodiments.

Results of OpenQAOA computations are saved in accordance with the present embodiments in a suitable format (e.g., JSON) featuring two first-level keys denoted in the illustration 200 as ‘Header’ 210 and ‘Data’ 250. The ‘Header’ 210 contains data that is useful to index the record in, for example, a SQL database. The ‘Data’ 250 contains arbitrary (and not necessarily structured) data, which can be seen as a data dump from the execution of the algorithm. Crucially, the data in the ‘Header’ 210 is the link that enables the computational data to be stored with context. Finally, note that the metadata component 215 of the ‘Header’ 210 can contain, if the end-user desires, key-value pairs extracted from elements of the ‘Data’ 250.

Given the current size of available quantum computers and the price of using them, practitioners typically execute QAOA computations on around at most one hundred qubits. The number of shots taken of each circuit is typically around a few thousand (less than 10,000), while the number of optimizer iterations is typically around one hundred at most. Assuming the quantum computing provider 173 (FIG. 1) returns a list of the outcomes from each shot as an array of zeros and ones (one value for each qubit measured), with the numbers stated above the data received is not particularly inconvenient in size. For example, suppose the following scenario (Scenario 1): 1000 shots per circuit; one hundred optimizer iterations; two function evaluations per iteration (e.g. using simultaneous perturbation stochastic approximation (SPSA) as the optimizer); and one hundred qubits. Overall this results in a data output of around 20 million ones and zeros, in whichever format they may be returned (e.g., in Python as int64, bool, etc.). This is manageable in terms of the data footprint, reaching into megabytes at most.

It is plausible that in the future quantum computers with thousands of qubits will be available and the cost of quantum computing reduces to the point that one can affordably run QAOA computations consisting of thousands of optimizer iterations and many thousands of shots per circuit. Consider the following example scenario (Scenario 2): 100,000 shots per circuit; 1000 optimizer iterations; two function evaluations per iteration, with SPSA; and 1000 qubits. The resulting data footprint of Scenario 2 is four orders of magnitude larger than that of Scenario 1. In other words, the user would now receive 200 billion ones and zeros (in some format) of raw data. Since this could extend into gigabytes of storage, it is inconvenient to work with and potentially costly to store. One could argue that practitioners do not routinely store the outcomes of every shot taken, and the above argument may overstate things. On the other hand, there could plausibly be utility in storing such data for software and hardware debugging, research, or analysis with machine learning algorithms for a purpose. Raw data may turn out to be useful in ways that are currently not understood or envisaged.

OpenQAOA addresses this problem by allowing the user to serialize the result into conceptually independent chunks that can then be individually indexed, compressed, and archived. The user is free to define the atomic result of a given experiment where atomic results represent the smallest, contextual block of data into which a user is willing to serialize an experiment/computation. Crucially, the atomic result only needs to satisfy one property-namely, it always needs to contain all the necessary metadata to interpret the rest of the stored data. That is, at any given moment in the future the user can load any serialized chuck of data and manage to recreate the original result. The actual size of an atomic result is thus arbitrary. For example, one way to achieve the desired result is by splitting the result object into two key-value pairs. The header key (e.g., the Header 210) contains the indexable, searchable portion of the stored data and the data key (e.g., the Data 250) contains the raw data corresponding to an atomic result.

The raw data 250 can be compressed and then archived to minimize the data footprint by using any regular off-the-shelf compressing algorithm. The header 210, on the other hand, can be ingested within a standard relational database, for example, to allow for quick and efficient retrieval of the stored and compressed data portion of the result.

The OpenQAOA Results Object (RO) 135 (as exemplified in the illustration 200) contains data on the results of a computation, metadata pertaining to the algorithmic settings and the backend used, as well as any contextual information provided by the user. Particularly noteworthy objectives of the RO 135, and the advantages they confer are several. A first objective of the RO 135 is to achieve optimal data compression such as minimising the memory footprint while allowing all required information on the experiment to be fully re-constructed. The data organisation and compression methods of the RO are particularly important for users executing a large number of computations and/or those executing computations using many qubits. In those situations, the volume of raw data produced may become inconvenient to work with and expensive to store. The RO 135 therefore contributes to the advantageous scalability provided by OpenQAOA in tackling large workflows in accordance with the present embodiments.

A second objective of the RO 135 is to provide logs of the optimisation history, allowing the performance of the algorithm to be tracked through the iterations. This allows the user easy access to information that is useful in the research and prototype phase, thereby contributing in accordance with the present embodiments to workflow efficiency.

A third objective of the RO 135 is to provide a clear map (e.g., as a dictionary) of the binary variables defined in the problem statement to the result of the QAOA computation. This could optionally be extended to named variable groups for problems built into OpenQAOA, such as those in the Problem Class Module 152. For instance, for the knapsack problem the binary variables in the solution could be annotated as ‘decision variables’ and ‘slack variables’. These features facilitate the interpretation of the data and therefore also contribute to the overall workflow efficiency.

A fourth objective of the RO 135 is to allow the user to add context to their data, which can later be used as a criteria for searching a results database. In this way, identifiers from the backend provider such as job IDs can be connected to identifiers relevant to the user, such as the algorithmic settings used and a project name.

More generally, the focus on data labelling and the ability to re-construct the full data by the results object 135 in accordance with the present embodiments is intended to ensure reproducibility of experiments, and the following of best practices.

Moving back to discussion of the OpenQAOA Enabler 150 in the schematic illustration 100 the first module is the Problem Class Module 152. The problem statement is the only input parameter the user is required to specify (default options will exist for all other input variables). The user has two choices in this regard. First, the user may explicitly provide the binary or Ising formulation of the problem. This, of course, requires the user to know the required formulation and how to specify it in a format accepted by OpenQAOA. Second, the user may select a problem from OpenQAOA's set of built-in classes, and these classes of selectable problems can be selected from within the Problem Class Module (PCM) 152. These problems include the most common optimisation problems, including the travelling salesperson (TSP) problem, the bin packing problem, the knapsack problem, the number partitioning problem, and the job shop scheduling problem. The user simply specifies the data corresponding to the problem instance—e.g., for the TSP, a matrix of the distances between cities; or for the knapsack problem, a list of the weights and values of the objects. If the SDK does not contain a built-in class for a specific problem, the user can extend the PCM 152 and build a new class for the particular problem of interest. The newly defined problem statement class can then be used within the SDK/OpenQAOA.

The PCM 152 facilitates and promotes workflow efficiency. By removing the burden of providing the binary or Ising formulation of the problem, the user saves time and effort. A problem in OpenQAOA can be set up directly from the data pertaining to the problem instance, e.g., a matrix of relative city locations for TSP. Moreover, the ability to easily add custom problem classes extends the utility of the PCM 152 to the user's specific requirements.

The PCM 152 also ensures workflow consistency and reproducibility. When the PCM 152 is used, one ensures that the same mathematical conventions are employed when executing computations of the same problem class. Moreover, using the PCM 152 reduces the likelihood of making errors (correctness) as compared to manually setting up a problem of a supported class. Concrete examples where these considerations are relevant include the interconversion of Ising and QUBO forms of the problem, the treatment of constant energy shift terms in the cost/objective function, and the mapping of the problem into a representation used consistently throughout the computation. All of these benefits can relate to the workflows of a single user, or of a plurality of users working together.

The Circuit Compilation Module (CCM) 153 is responsible for qubit selection, qubit mapping, qubit routing, and subsequent post-processing procedures as discussed hereinabove. The CCM 153 comprises a library of algorithms designed to tackle these problems and takes its input from, and delivers its output to, the Circuit Compilation Interface.

The minimum required input information for the CCM 153 consists of a problem statement such as an Ising or QUBO Hamiltonian in a suitable representation, and a device on which the computation is to be executed (e.g., one of the provider devices 173). Additional options may be provided, such as a specification of the algorithm(s) to be used for compilation, and any settings associated with them. The CCM 153 has two major goals. The first goal of the CCM 153 is to provide the necessary information allowing the OpenQAOA Core 110 to construct a circuit that can be executed on the target device (i.e., a circuit that respects the connectivity of the device). In addition to the previous point, a second goal of the CCM 153 is to optimise the circuit such that the proliferation of noise is kept to a minimum. This can be achieved by targeting several metrics, such as minimising the number of SWAP operations required in qubit routing, selecting a group of qubits on which the fidelity of quantum gates is highest, minimising the depth of the quantum circuit, or any combination of these metrics and other similar metrics.

The CCM 153 returns to the CCI all information required to construct the circuit such that it can be executed on the specified hardware device. Thus, it can be seen that the CCM 153 is an essential element of OpenQAOA for enabling scalability since effective circuit compilation is critical for large-scale QAOA computations.

Error mitigation techniques can help improve the quality of results obtained from QPUs, typically at the extra expense of taking a larger volume of data or lengthening the circuit to be executed. Such methods will become more practically attractive as the cost of quantum computing comes down and may become an indispensable component of QAOA workflows. The OpenQAOA's Error Mitigation Module (EMM) 154 is designed to bring the benefits of error mitigation to QAOA workflows. Error mitigation techniques are diverse in the ways that they work, and in where they must be applied in a workflow. For example, there exist techniques that modify the target QAOA circuit, by inserting additional gates or operations. Examples of such methods include zero-noise extrapolation and dynamical decoupling. These techniques must be applied before the circuit is sent to the backend 170 for execution. The techniques in this category may require multiple different circuits to be constructed from the target circuit. Examples include methods using randomised compiling and twirling.

There also exist techniques that do not modify the target QAOA circuit, but which may require additional calibration or reference circuits to be constructed and executed. In both cases, after a first call to the EMM 154 to construct any additional or modified circuits and subsequent circuit execution, a second call to the EMM 154 may be made for the purposes of post-processing the results, if required by the technique being used.

At a minimum, the EMM 154 takes as input from the Enabler Interface (and more specifically, the Error Mitigation Interface) the target QAOA circuit and a specification of the error mitigation technique to be used. Additional input may include settings associated with the error mitigation technique and a description of any data related to the target backend that may be necessary. The EMM 154 can access this data by communicating with the provider's systems or the user can specify it explicitly.

The EMM 154 returns different information to the OpenQAOA Core 110, through the Error Mitigation Interface, at different stages of the workflow. For example, after a first call the EMM 154 may return modified circuits to be dispatched by the OpenQAOA Core 110 to a backend 170. After a second call for data pre-processing, the EMM 154 will return information that allows the Results Object 135 in the OpenQAOA Core 110 to be updated or augmented.

The EMM 154 enhances OpenQAOA by providing features that can significantly improve the performance of QAOA. Users can call powerful techniques with a minimum of effort and/or required knowledge. Moreover, error mitigation is essential for scalability of QAOA, especially when one works with large-scale computations.

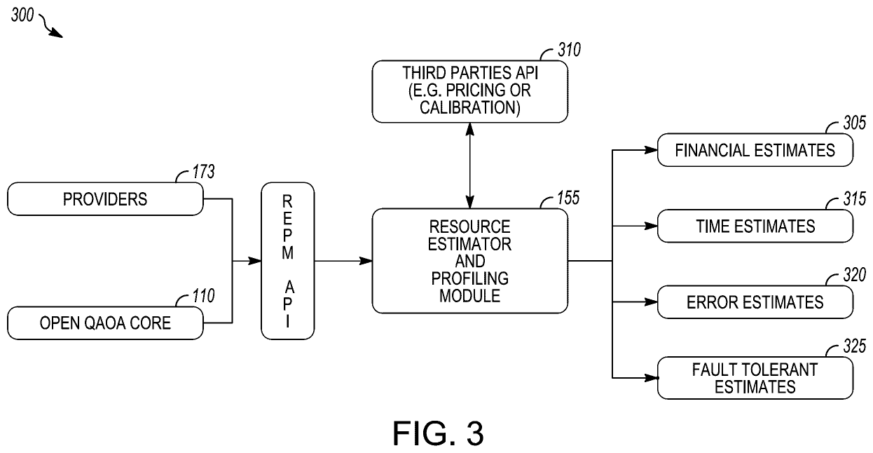

The Resource Estimator and Profiling Module (REPM) 155 provides the user with information relating to a circuit that has been constructed in OpenQAOA for execution on a specific target backend. It is intended to assist the user in evaluating the resources required to meet their objectives. Referring to FIG. 3, a block diagram 300 depicts operational connectivity for the REPM 155 in accordance with the present embodiments. The REPM 155 takes as input the quantum circuit constructed by OpenQAOA's Core Module 110 and the name of the target device (the selected one of the providers 173) on which it should be executed. It is beneficial to use the Circuit Compilation Interface in the circuit construction step, since this will allow the REPM 155 to provide a more accurate estimate of the various resource requirements.

Examples of information that can be calculated and returned by the REPM 155 include an estimated cost of execution (i.e., financial estimates 305) for a specified number of optimiser iterations and shots to be taken. This requires the REPM 155 to have access to the provider's pricing information for the device being targeted. Such information may, for example, be accessed by an API call to the provider's systems 310 where possible, or it may be specified by the user directly.

The information that can be calculated and returned by the REPM 155 also includes estimated execution time of the circuit (i.e., time estimates 315). This requires the REPM 155 to have access to the provider's gate execution times. Again, these may be accessed via API call to the provider's system 310, or passed in by the user.

The information that can be calculated and returned by the REPM 155 also includes a comparison of the estimated circuit execution time to the coherence time(s) of the qubits being used, and/or some statistical features of the set of coherence times (e.g., the time estimates 315). The required information may be provided to the REPM 155 as described in the preceding points.

The information that can be calculated and returned by the REPM 155 also includes an estimate of the probability of different numbers of errors occurring in the circuit (i.e., error estimates 320). For example, given data that characterises the error rates of the single-qubit and two-qubit gates of the target device (as may be derived from randomised benchmarking, cycle benchmarking, tomography, or other suitable methods) it is possible to compute the probability P_{1Q}(m) of m single-qubit errors occurring in the circuit. Similarly, one could compute the probability P_{2Q}(m) of m two-qubit errors occurring. Such computations are estimates, and assume that errors occur independently of one another.

The REPM 155 can also provide resource estimations for the case where the circuit is intended to be executed in a fault-tolerant manner (i.e., fault tolerant estimates 325). For instance, given the logical-level QAOA circuit produced by the OpenQAOA Core 110 (this time not produced in conjunction with the CCI), together with device information (e.g., gate execution times, basic error rates) and the details of a quantum error correction scheme, the REPM 155 can estimate quantities such as the number of physical qubits required, the execution time of the circuit, and the number of gates of different types.

The REPM 155 provides OpenQAOA with valuable features for computational workflows. Estimating resources and analysing data relating to the execution of the algorithm on a particular device allows users to make informed decisions on where or how to run their computations, and the REPM 155 is designed to facilitate this.

AutoVQA 156 is another module provided by the Enabler 150 in accordance with the present embodiments that may help users create VQAs that match the specific problem at hand. In general, VQAs do not come as a one-size-fits-all algorithm but instead need to be tweaked and changed depending on the particular situation at hand. A user passes the input statement to AutoVQA 156 and, in accordance with the present embodiments, receives a ranked selection of the different available parameters (such as the circuit ansatz, the parameterization, and the optimizer). The ranking is obtained by combining statistical methods over the input, using machine learning classifiers built from the historical set of previous computations, and a proprietary rule-based system. These methods include: a) statistical analysis of the problem, b) comparisons of the problem instance with previous problem instances via machine learning approaches, and c) rule-based systems based on the technical understanding of VQAs. The comparisons of the problem instance with previous problem instances via machine learning approaches clusters the problem type and selects the optimal components for the quantum algorithm by, for example, using machine learning on historical data to predict the most effective optimizer. AutoVQA 156 then ranks the different components and suggests what to use. AutoVQA 156 addresses scalability issues by avoiding blunt prototyping.

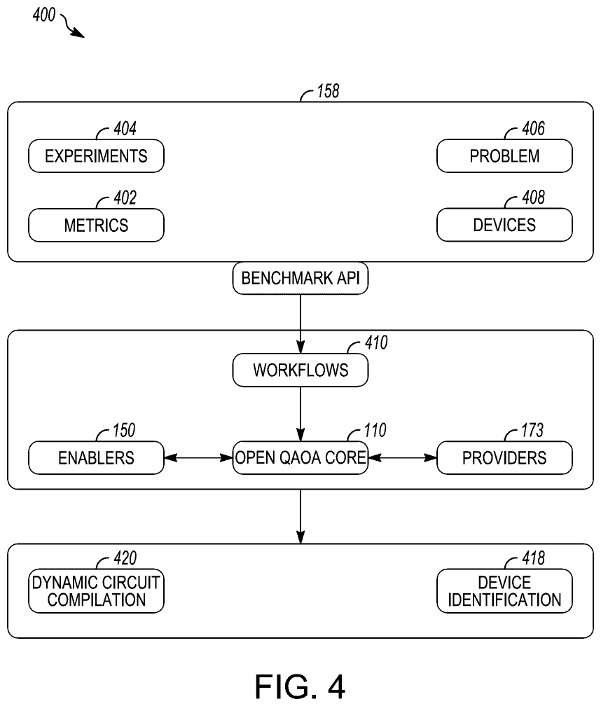

OpenQAOA provides a module containing methods for benchmarking QAOA under various conditions, the benchmarking module 158. Benchmarking is an essential part of designing and assessing the performance of any algorithm and the environment in which it is executed. OpenQAOA's Benchmarking Module (BM) 158 is designed to facilitate and enhance QAOA benchmarking workflows. Referring to FIG. 4, a block diagram 400 depicts operation of the Benchmarking Module 158 in accordance with present embodiments. The role of the BM 158 is to leverage functionalities within the OpenQAOA core 110 (and, subsequently, enablers 150, providers 173, and workflows 410) to track metrics 402 of interest, experiments 404, problems 406, devices 408 and other benchmark data. The experiments 404 contained in the BM 158 are designed to expose key aspects of the QAOA algorithm and the devices 408 being used to execute it. The benchmark module 158 can then be dynamically used to not only access static properties of devices 418 (such as Quantum Volume or Q-Score) but also as a key component in the compilation step of a QAOA. For example, the information acquired through the benchmark module 158 can be used to choose a circuit compilation 420 or an error mitigation technique 154 that is optimal for the noise witnessed.

QAOA can be executed with noise in a controlled manner on a suitable classical simulator as discussed hereinabove. When executed on a QPU, QAOA is subject to the noise processes of the device, which cannot be characterised exactly in an efficient manner; typically, only average statistics about the fidelity of certain operations are known. I t is thus of interest to have a set of standardised, problem-centric benchmarks that are indicative of the performance of a given device 408.

Examples of experiments 404 (computations) in the BM 155 include, but are not limited to, parameter landscape sweeps, including unweighted Max-Cut problems on k-regular graphs, and analytic formulae. Parameter landscape sweeps for problems amenable to theoretical analysis both with and without noise are examples of experiments 404 in the BM 158. For example, the canonical problem of unweighted Max-Cut for the Ring of Disagrees (a ring graph) using the Standard parametrisation and for a single QAOA layer has an optimal solution independent of the problem size (i.e. the angles γ and β in the QAOA circuit that provide the optimal solution do not depend on the size of the ring). When executing this computation on a real QPU, the degree to which the performance deviates from the expected result as the user varies the problem size provides a helpful indication of the device's suitability for running large quantum computations. A variation of this experiment is to execute unweighted Max-Cut problems on k-regular graphs, where k is some integer. For any k, as the number of nodes in the graph tends to infinity, the optimal solution (i.e. the angles α and β) also become independent of the problem size.

In some limited and simple cases, analytic formulae can be obtained for the performance of QAOA in the presence of noise and are examples of experiments 404 in the BM 158. The conditions under which these results can be derived typically correspond to basic Pauli noise processes. For example, a Max-Cut on the Ring of Disagrees parameter sweep experiment (as described hereinbefore) can reveal characteristics of the noise present on a given quantum computer by reference to analytical calculations that assume certain noise processes. These experiments 404 can be executed quickly and cheaply, since they require no actual optimisation and they are run with known fixed parameters.

The BM 158 also includes a range of publicly available experiments relevant to benchmarking QAOA and the devices upon which it is executed, such as Quantum Volume, Q-Score, and QED-C QAOA benchmark algorithm.

The BM 158 provides advantages to the user in several ways. First, the experiments 404 are designed specifically to expose useful metrics or characteristics of QAOA or a device on which it is being run. The user can readily execute the experiments 404 with a minimum of effort, and the information obtained can be used to inform possible next steps, such as deciding which QPU to use for a wider set of experiments in a project. In other words, actionable information is obtained efficiently.

Next, a tailored bank of rigorously tested and vetted experiments 404 ensures consistency and reproducibility for a user or group of users and reduces the likelihood of errors being made.

OpenQAOA provides an extensive set of simulators, i.e., backends 170 that simulate the behaviour of quantum computers. The simulator suite in accordance with the present embodiments is designed to allow the user to investigate the performance of QAOA under a range of research situations. For example, statevector or wavefunction simulators mimic the behaviour of a noiseless quantum computer and return the full output wavefunction; Master Equation and Quantum Monte Carlo Wavefunction simulators mimic the behaviour of a quantum computer in the presence of known noise processes acting continuously on the system; error-based simulators (e.g., EE and DEWF simulators) focus on the effects of noise occurring at specific locations in the quantum circuit; and specialised simulators for computing specific properties of the output of a QAOA circuit, which are based on explicit mathematical formulae derived from analytic analysis (for example, the single-layer simulator (SLS)).

The suite of simulators allows the user to thoroughly investigate the performance of the QAOA and how it can be affected by noise. Consistency, reproducibility, and correctness are achieved through the standardisation of implementations of the different simulator types. Building a simulator, especially one incorporating noise, requires significant expertise, care, and testing to ensure correct behaviour. Moreover, to ensure that different simulator types can be used to obtain complementary views of the same research question, the mathematical and scientific conventions used must be consistent across the simulator suite.

Workflow efficiency follows from having access to multiple different simulator types, all of which can be called with minimal modification of the user's basic code. As an example, the following Python pseudocode indicates the general syntax that can be used (although note that OpenQAOA is not limited to being implemented in Python):

# Create the QAOA
q = QAOA( )
# Create a device
device = create_device(name, credentials, options)
# Set the device
q.set_device(device)
# Compile and execute the algorithm
q.compile(input_problem)
q.optimizer( )

Here, in the line where device is created, one can modify the target backend to be any simulator or QPU.

The Standard Plotting Module (SPM) 186 facilitates the visualisation of standard data which may be provided in the form of array- or matrix-type data structures. The SPM 186 is the workhorse for producing figures, plots, and illustrations of numerical and categorical data obtained from running computations, or in the stages of their preparation. It can also be used for the visualisation of graph data, in the sense of structures with a set of nodes and edges.

For example, the SMP 186 can be used to plot the history of the cost function over all optimiser iterations in a QAOA computation; plot the scaling of QAOA performance as a function of some parameter, such as the number of layers or the problem size; plot information originating from computations executed by the REPM 155; or plot and annotate graph structures, composed of nodes and edges. For example, one may wish to visualise the output of a computation defined on a graph where, in the visualisation, the nodes and edges of the graph are coloured in such a way as to illustrate the solution.

The Circuit Diagram Visualiser (CDV) 190 allows for the visualisation of a quantum circuit in its standard representation. That is, the CDV 190 produces an image of a series of wires, each representing a qubit, upon which gate operations are performed.

The Circuit Compilation Visualiser (CCV) 188 is a specialised feature that facilitates the visualisation of how a target circuit is compiled to a desired backend. The results of qubit selection, qubit mapping, and qubit routing are generally non-intuitive for humans and present a challenge for users to examine in detail. The CCV 188 offers a number of different ways to view the results of such circuit compilation steps which may assist the user in identifying patterns and developing better intuition for these problems in general. A few examples of how the CCV 188 achieves these goals follow.

As a first example, given one or several qubit selection maps (i.e., a specification of which qubits on the target device should actively be used to execute the target computation), an illustration of the device can be annotated with the qubits that have been selected. Where several selection maps are to be compared, accompanying numerical data quantifying the quality of each selection map may also be included in the visualisation.

As a second example, given a qubit routing schedule (e.g., a list of the sequence of SWAP operations that must be performed), the CCV 188 supports several visualisation methods. First, let each physical qubit be represented by a wire, as in the standard representation of quantum circuits, where time flows from left to right. When two qubits are swapped, their wires cross over one another. A full visualisation of the routing schedule can be built by crossing wires over one another in this way at the relevant instants in the circuit. In effect, this constitutes a visualisation of the QAOA circuit in the standard representation, using the standard representation of a SWAP gate, and where all other gates have been removed. In other words, the standard circuit diagram is stripped back to show only the SWAP operations. Second, a graph representation of the target device is constructed to reflect its true connectivity (the ‘device graph’); each node in the graph represents a physical qubit, and when a pair of nodes are connected by an edge, a SWAP operation may be performed between them. An animation is produced, consisting of a series of frames representing each instant in the circuit. In each frame, the illustration of the device graph is annotated with the locations of the SWAP operations that take place in the corresponding circuit instant. Alternatively, each node in the device graph may be labelled with, for example, a number, denoting the logical qubit corresponding to each physical qubit. If a SWAP operation is performed, logical qubit indices are permuted, and this is reflected as the illustration moves from frame to frame. That is, when a SWAP operation is performed, the numbers in the graph representing the logical qubit indices are switched.

Graphics produced by the GUI can be saved using standard commands executed directly within the GUI in the save and load 192. Likewise, previously generated graphics can be loaded in the save and load 192. Experimental data in an OpenQAOA Results Object can also be loaded in the save and load 192 and examined conveniently.

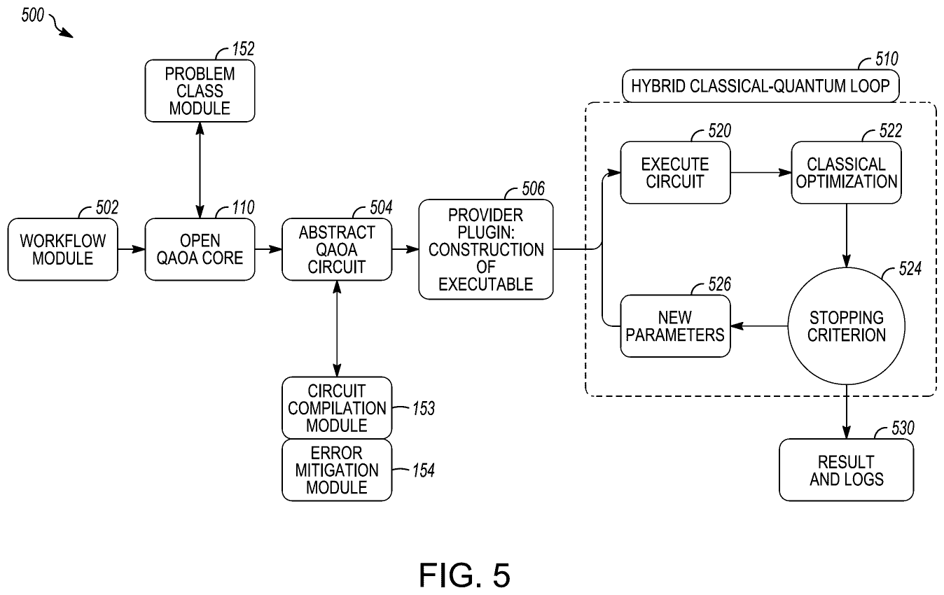

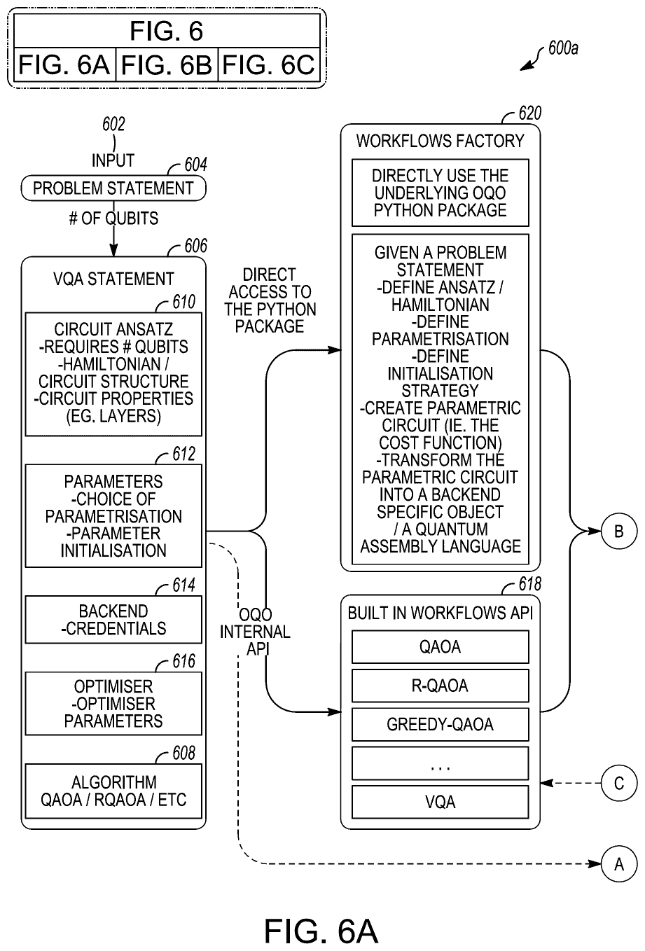

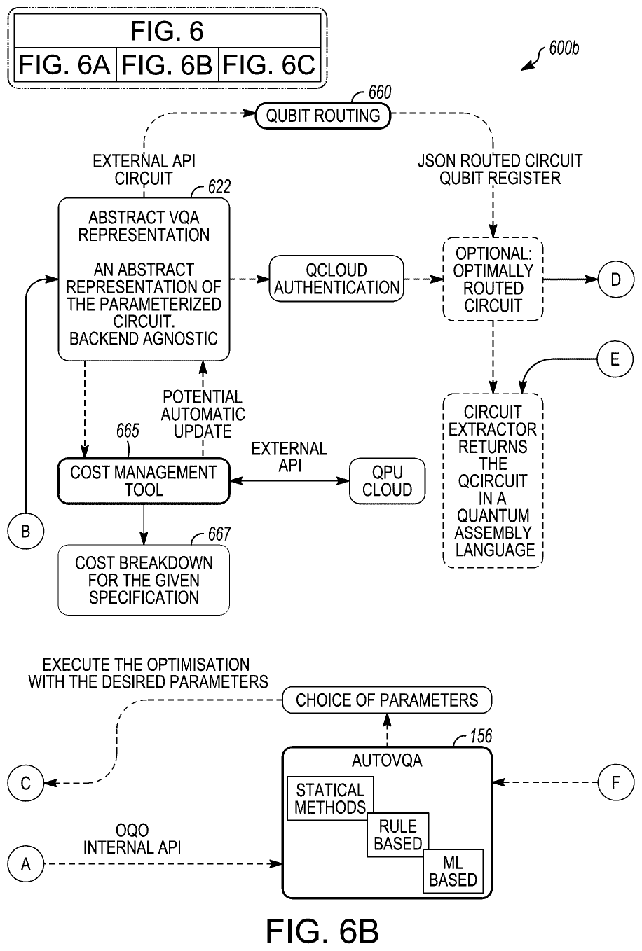

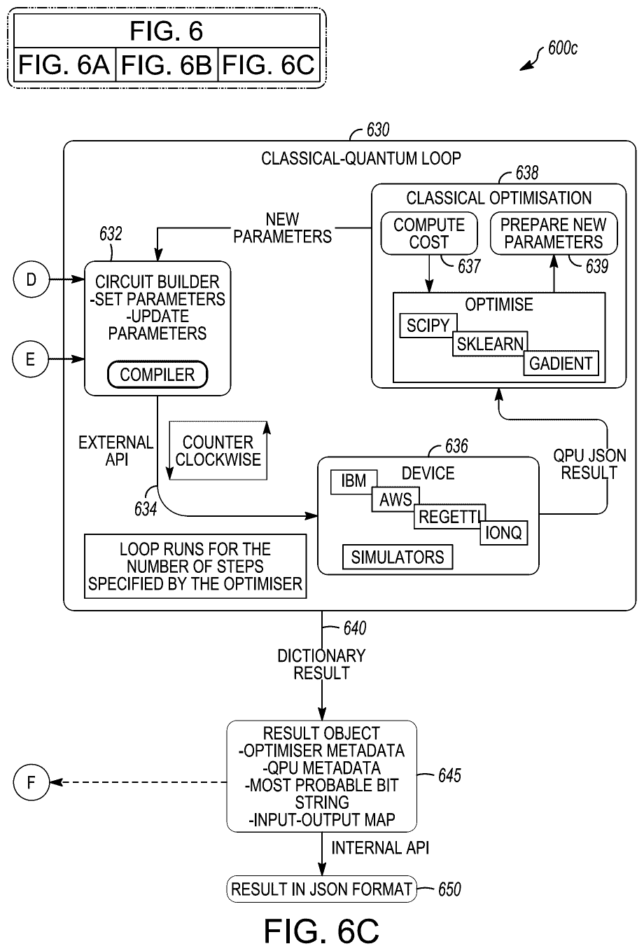

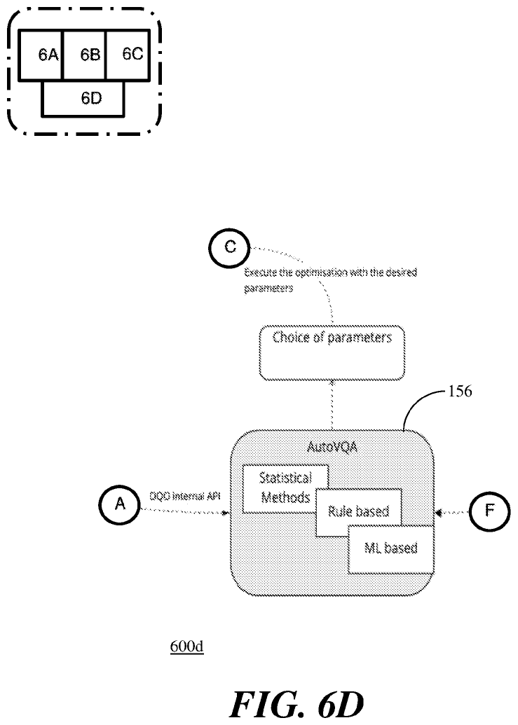

FIG. 5 depicts an illustrative representation 500 of a generic OpenQAOA Workflow in accordance with the present embodiments. The OpenQAOA Core 110 is responsible for both connecting through APIs to the enabler layer 150 and the plugins 160 and executing the hybrid classical-quantum loop 510 that drives the actual QAOA. From a workflow module 502, the OpenQAOA Core 110 receives workflows, utilizing the problem class module 152 to develop the problem statement for the workflow. More specifically, the user provides input data where one part of the input is derived from the problem class module 152 (i.e., the Hamiltonian, which ultimately becomes a list of terms and weights.) and the other part is a specification of the algorithmic settings, the compilation procedures to use (or anything else to be called from the Enabler 150) and the backend details. The input is then given to submodules of OpenQAOA core 110 where the workflow module 502 has the role of orchestrating the execution of the whole algorithm and the workflow module 502 also connects to the enabler modules 150 and the provider modules 173. It is important to note that, in accordance with the present embodiments, the user can also opt out of the pre-defined workflows of the workflow module 502 and build their own through a workflow factory module.

From the OpenQAOA core 110, an abstract QAOA circuit 504 is generated utilizing enablers such as the circuit compilation module 153 and the error mitigation module 154. Core features of the OpenQAOA in accordance with the present embodiments are defined as those modules which are device-independent. That is, they represent code which has been abstracted from the details dependent on the specific target quantum computer. Code which depends on the specific target quantum computer is contained either in the enabler modules 150 or in the OpenQAOA plugins 160.

The OpenQAOA Enablers 150 are always connected to elements of the OpenQAOA core 110 via the APIs 140. The enablers may, effectively, be called before a workflow (e.g., the problem class module 152 as shown in the diagram 500), during a workflow (e.g., the circuit compilation module 153 and the error mitigation module 154 as shown in the diagram 500), separately of a workflow (e.g., the resource estimator and profiling module 155 and the autoVQA 156), or included in many workflows (e.g., the benchmarking module 158). The circuit compilation module 153 is obligatory to the execution of any workflow as it is necessary for generation of the abstract QAOA circuit 504. The compilation steps of qubit selection, mapping, and routing take place on the abstract QAOA circuit 504. After performing these compilation steps, the output is an abstract description of the original circuit that commits to a specific subset of qubits on the target device and accounts for the connectivity limitations of the device. Nevertheless, at this stage it is not yet a fully executable circuit and, as such, it remains an abstract QAOA circuit 504. The provider plugin 506 performs the task of converting the abstract QAOA circuit 504 into a fully executable circuit characterised by a series of physical pulse operations (e.g. microwave, optical frequency) or similar operations specific to the physical platform of the provider's technology. The function of circuit compilation is split into two parts: a device-independent part identified as the circuit compilation module 153 which is within the enabler 150 (FIG. 1) and the provider-compilation 506, which is device dependent and is part of the plugin/providers classification (i.e., plugins 160 (FIG. 1)).

The abstract QAOA circuit 504 is compiled to the selected provider by the provider-compilation 506 and fed to the hybrid classical-quantum loop 510. Within the hybrid classical-quantum loop 510, the compiled circuit is executed 520 on a simulator or on a QPU, and the variational parameters are optimized by classical optimization 522. If stopping criteria 524 is met, the results and logs 530 are outputted. If the stopping criteria 524 is not met, new parameters 526 are provided to the compiled circuit and the circuit is executed 520 again.

The illustration 500 shows how the core algorithmic elements of OpenQAOA interact with each other and how they connect to both the enabler and the plugin/provider layers. FIGS. 6A, 6B, 6C and 6D together depict an illustration 600 (shown as 600a, 600b, 600c and 600d) of the computational workflow in accordance with the present embodiments showing a more detailed breakdown of how information flows between the elements of the OpenQAOA core 110 and the enablers 150 and plugins 160/provider components 173. While the illustration 100 (FIG. 1) depicts a hierarchy of dependencies of the different components of the OpenQAOA in accordance with the present embodiments, the illustration 600 depicts a computational workflow of how information flows in accordance with the present embodiments between the different components of the OpenQAOA. As discussed hereinabove, the Core 110 provides the most basic and fundamental routines and functionalities required to run a QAOA computation, and the Core 110 is independent of the backend 170 where the computation is to be run. The Enabler 150 and the GUI 185 depend on some previous task(s) being performed in the Core 110 and they take information from the Core 110 and perform actions with that information. And the Backends 170 require prior use of both the Core 110 and the Enabler 150, the use of the Enabler 150 being required, if nothing else, for circuit compilation 153.

The illustration 600 more closely reflects the flow of information between components during a computation where solid lines represent required flow of data and dashed lines represent optional flow of data. While the schematic illustration 100 depicts a hierarchy, in actual QAOA computations information is passed back and forth between the distinct OpenQAOA elements such as the Core 110, the Enabler 150, and the Backends 170 in a non-linear way. For instance, having executed a circuit on a backend 170 and obtained data from it, the data is returned to the Core 110. If an error mitigation method has been specified, at this stage a call to the Error Mitigation Module 154 in the Enabler 150 may be made to post-process the data, before passing this updated data back to the Core 110. Next, in the Core 110 the classical optimizer that updates the variational parameters is run. A new quantum circuit is then constructed, which is subsequently passed through to the backend 170, establishing a loop until the termination criteria are met.

A second illustrative example of how information can flow in non-trivial ways is during computations with R-QAOA, a modified version of basic QAOA. In this case, after processing data in the Core 110 obtained from a backend 170, the optimization problem to be solved is modified from (but related to) the initial problem. Thus, a new circuit needs to be constructed in the Core 110 which subsequently needs to be compiled by the Compilation Module 153 before eventual execution of the new circuit takes place on a backend 170. The illustration 600 (FIGS. 6A, 6B, 6C and 6D) depicts the non-linear flow of a computation that makes use of the different components of the Core 110, the Enabler 150, the Backends 170, and possibly the GUI 185.

OpenQAOA in accordance with the present embodiments is a reference implementation of a multi-backend SDK for variational quantum algorithms (the Solution). OpenQAOA can be divided into two distinct parts: the core algorithmic components, comprising of a set of internal APIs whose role is to build optimisation workflows; and a set of enabling and visualisation components, which can be integrated with the workflows (e.g., the compilation module 153 and the error mitigation module 154) or as standalone tools (e.g., the benchmarking module 158 or the Resource Estimator and Profiling Module 155).

The most basic VQA that OpenQAOA in accordance with the present embodiments can implement is QAOA. QAOA is a general algorithm to find approximate solutions to combinatorial optimization problems. Since its introduction in 2014, QAOA has garnered particular attention due to its ability to run on NISQ devices and the hope that QAOA will feature a relative speed-up compared to state-of-the-art classical optimization algorithms. While it is possible to identify a standard QAOA in the original protocol introduced, it is now reasonable to talk about a family of QAOA algorithms. Within the QAOA family of algorithms, many modifications and extensions of the standard QAOA algorithm exist. Yet, one can define a set of structural features; thus, a QAOA instance is given by a parametrized quantum circuit of fixed structure whose parameters are trained by an optimization algorithm that uses evaluations of the given quantum circuit either on a simulator or on a quantum device.

Referring to FIG. 6, the first step to creating a VQA using OpenQAOA is input creation which occurs at the Input 602. The Input 602 is composed of two parts: the Problem Statement 604 and the VQA Statement 606. The Problem Statement 604 is the only input parameter the user must specify because the Problem Statement 604 is a required dependency of the VQA Statement 606. There are two choices for the user: either the user selects a built-in class of problems from the problem class module 152 or the user provides a binary formulation of the user's problem. The OpenQAOA in accordance with the present embodiments has built-in types for a set of well-known optimization problems (like the Travelling Sales Person problem or the Number Partitioning problem) in the problem class module 152 to simplify the construction of the input 602. If the SDK does not contain a built-in class for a specific problem, the user can extend the problem class and build a new class for the particular problem of interest. The newly defined Problem Statement class can then be used within the SDK. The Problem Statement 604 determines the minimum number of qubits required by the VQA by considering how many unique variables are specified.

The VQA Statement 606 specifies the defining parameters of the VQA 608. The parameters are JSON-compatible data primitives (i.e., integers, floats, strings, Boolean, etc.) and include the Circuit Ansatz properties 610, Variational Parameters 612, Backend 614, and Optimizer 616. The Circuit Ansatz properties 610 include the total number of qubits, the Cost Hamiltonian, and the Mixer Hamiltonian, which, in turn, specify the circuit ansatz and the circuit parameters (such as the number of layers). The Cost Hamiltonian, of course, depends on the Problem Statement 604. The Variational Parameters 612 are a set of fields specifying the variational parametrization of the circuit. The Variational Parameters 612 contain the choice of parametrization and the parameter initialization strategy. These variational parameters are optimized in the classical-quantum loop.

The Backend 614 must provide the backend name and the credentials (if a QPU or a cloud-based simulator) and the location of the backend (e.g., local or the name of the cloud provider) alongside all additional information required by the backend (for instance, the number of measurements). Backends 614 can also be simulators. The optimizer is the classical-quantum loop.

The OpenQAOA in accordance with the present embodiments provides built-in methods to create both the Problem 604 and the VQA Statements 606. That is, the user is not required to write either from scratch. The SDK provides an API to convert the Problem 604 and the VQA Statement 606 from JSON-compatible data primitives into code that a Backend 614 can execute. This conversion is important within the design of an optimization SDK since it ensures consistency at the level of the mathematical statement of the optimization problem and provides a standardized way to build quantum optimization algorithms.

The internal API of the SDK is used to construct workflows to solve the optimization problems. The user, via the API, can follow two routes: using Built-In Workflows 618 or creating a workflow from scratch in the Workflows Factory 620. Built-in Workflows 618 are ready-to-use implementations of quantum algorithms (QAOA, Recursive QAOA (R-QAOA), Greedy QAOA) that require minimal user intervention. They take as input the Problem Statement 604 and the VQA Statements 606, convert the underlying algorithm into an executable workflow, and return as output a result containing the optimization result and all the relevant metadata from all used algorithmic aspects (for example, metadata from the simulation/quantum computer and the classical-quantum loop optimization). The Built-in Workflows 618 have a default set of parameters. Therefore, a user who is just getting started with variational quantum algorithms only needs to choose a Problem Statement 604 and select the desired VQA workflow. Extensive customizability is available also for the Built-in Workflows 618, where the user can specify selected properties of the VQA Statement 606. The user may choose between circuit ansatzes 610, parameterizations and initialization strategies 612, classical optimizers 616, and backends 614. For instance, in the case of the initialization strategy, the user can choose between predefined schemes or opt for a custom option to provide an arbitrary set of circuit gates parameters.

In the Factory 620, a user can modify the entirety of a workflow. The source code of the Built-in Workflows 618 is available to the user in the Factory 620, and the user can change the order of the operations or introduce different logical structures. Technically, all workflow components are solely defined in terms of the input/output relations. This design enables swapping parts as long as the I/O connections are satisfied.

Whether one uses the Built-in Workflows 618 or the Factory 620, the SDK's API converts the input into a backend-agnostic representation of the VQA computation. The agnostic attribute allows a VQA structure that is entirely independent of any specific practical implementation. The Abstract VQA Representation 622 is the abstract definition of the input, the structure of the VQA circuit and the CQL.

If we define QAOA as the most basic VQA that OpenQAOA can implement, then the built-in workflow can also construct non-trivial extensions of QAOA. Two examples of such extensions are Recursive-QAOA (R-QAOA) and Greedy-QAOA (G-QAOA). R-QAOA is an algorithm that recursively runs QAOA to solve an optimization problem. At each recursion step, a new, smaller instance of the QAOA is generated. The output statistics of QAOA at each stage are used to impose a constraint (or more than one constraint) on the system, which enables the elimination of one (or more) qubit(s) from the problem statement. When a small enough problem size is reached, the problem is solved exactly using a classical method. The solution to the original problem is then retrieved by backtracking through the constraints imposed at each step, using the exact solution computed at the end of the recursion.

G-QAOA is a modification of QAOA where each layer is optimized independently. The algorithm begins by specifying a circuit with a single layer, i.e., p=1. This circuit goes through the classical-quantum loop and the parameters associated with this layer are optimized. Once the p=1 parameters are optimized, anew circuit is defined. The new circuit corresponds to a p=2 circuit, where all the parameters belonging to the p=1 layer are fixed and the classical optimizer loop will optimize only the p=2 parameters. This procedure is repeated for all the layers.

The core algorithmic components of OpenQAOA receive the definition of the Abstract VQA Representation 622 and proceed to create a Backend-specific quantum circuit and execute the classical-quantum loop (CQL) 630. The classical-quantum loop (CQL) 630 receives the Abstract VQA Representation 622. The orchestration of the CQL itself and the classical optimisation 368 are part of the core algorithmic components. The CQL 630 includes the execution of quantum circuits on QPUs or simulators. These are part of the Plugins 160 and Providers 170. If quantum backends are used, the CQL 630 will also need to connect to a Quantum Cloud and send/receive information.

To create the circuit, OpenQAOA uses information from the VQA Statement 606 to build the circuit. In OpenQAOA, the Circuit Ansatz (Ansatz) 610 is a fixed set of quantum gates repeated p times. Each repetition p is a layer of the circuit. The user can specify the variable p. The Ansatz 610 is VQA specific because the VQA determines the Ansatz's set of gates. In the case of QAOA, the set of gates contains the driver gates (associated with the Cost Hamiltonian) and the mixer gates (associated with the Mixer Hamiltonian). The driver gates build the QAOA evolution operator encoding the cost function of the Problem Statement 604, which is then minimized by the VQA. The user selects the mixer gates by choosing among a set of prefixed mixer gates structures or by specifying an arbitrary mixing strategy. The names mixer and driver follow the conventional QAOA scientific literature. The Circuit Ansatz 610 fundamentally stores backend-agnostic instructions on building the layers of the VQA on the final quantum circuit.

The Variational Parameters (or Parameters 612) specify the variational parametrization of the quantum circuit. The user has complete control over the parameterization strategy. For example, the user may assign the same value to all the Parameters 612 on a particular part of the Circuit Ansatz 610 (as in traditional parametrization of QAOA). In OpenQAOA, the user first chooses the type of parametrization and then its corresponding strategy. OpenQAOA supports a variety of parametrization types including an extended parametrization where given a circuit ansatz, each gate is specified by the same parameter; a standard parametrization where given a circuit ansatz, each gate in the mixer gate set is parametrized by a single value, and likewise for each gate in the driver gate set; and annealing where the parameters are built using an annealing schedule specified by the user. If the type is either extended or standard, then the user can choose between two different strategies: an original strategy where the parameters correspond to the original parametrization or a Fourier strategy where the parameters are the sine/cosine transform of the original parametrization.

Once the parameterization has been fixed, one needs to initialize the Parameters 612. The OpenQAOA SDK in accordance with the present embodiments offers a set of built-in initialization strategies including, but not limited to, a linear initialization strategy where the parameters are linearly initialized over the p layers by analogy to a linear quantum annealing schedule; a random initialization strategy where the parameters are randomly initialized; and a custom initialization strategy which allows a user to provide the values as a list.

All this information (i.e., the Circuit Ansatz 610 and the Variational Parameters 612, the problem statement 604, and the Algorithm 608) defines a Backend-Agnostic Representation 622 of the quantum circuit of the VQA. OpenQAOA further modifies this Agnostic Representation 622 of the circuit in order to obtain an abstract optimally compiled circuit which is in turn the input to the Classical-Quantum Loop 630, where the variational quantum algorithms targeting different backends and simulators are created.

Turning next to the Classical-Quantum loop (CQL) 630, the OpenQAOA in accordance with the present embodiments follows certain steps within the CQL 630 to execute the circuit and optimize the variational parameters. First, the Backend-Agnostic Representation is turned into a Backend-specific circuit by a Circuit Builder 632 and sent through an external API call 634 to the desired Backend device 636. The role of the QPU is to evaluate the circuit and return to the SDK the output dictionary of states and relative counts. Note that if a local simulator is being used for the evaluation, the external API call 634 may not be required. The cost function 637 is estimated from the measurement results and minimized by using the VQA's classical optimizer 638. The classical optimizer 638 then creates a new set of Parameters 639. The new set of Parameters 639 are used to update the parametrized circuit 632 and the new circuit is sent to the Backend device 636, which evaluates the new parametrized circuit. The classical optimization routine 638 executes the CQL 630 as per internal rules and the loop stops once the optimization concludes. After the optimization concludes, the OpenQAOA returns 640 a result to the user.

The Circuit Builder 632 converts the Abstract VQA Representation into an explicit quantum circuit representation compatible with the backend of interest. The Circuit Builder 632 creates the parametrized circuit in a Backend-dependent fashion and initializes the parameterized circuit's gates according to the initialization strategy. The Circuit Builder 632 also updates the parameters during the CQL 630 and connects to external APIs 634 to execute the quantum circuits on cloud-based quantum computing providers 636.

In accordance with the present embodiments, the OpenQAOA Backend 636 can prepare and run circuits on quantum hardware compatible with IBM Q devices (through Qiskit); AWS devices, and all gate-based devices supported by AWS Bracket (through the AWS Braket SDK); Rigetti's QCS (through PyQuil); Microsoft Azure, and all gate-based devices supported by Azure Quantum (through the Azure SDK); all devices that accept QASM2.0 and QASM3.0; all devices available that accept the quantum intermediate representation QIR; and on local simulators based on IBM's Qiskit or a Vectorized simulator which is a QAOA simulator built by Entropica Labs of Singapore.

The Classical Optimizer 636 obtains a cost value 637 for the specific choice of parameters using the quantum computation's results. Any function that satisfies the input/output relations within the CQL 630 is, in principle, a valid optimizer. OpenQAOA advantageously supports an extensive range of optimizers (and the users can extend the list). Supported optimizers include Scipy optimizers (a wrapper of all optimizers available through the scipy library); custom gradient optimizers (a set of gradient optimizers written by Entropica Labs extending the Scipy library); machine learning optimizers (reinforcement learning agents trained by Entropica Labs); and PennyLane Optimizers (a wrapper of all optimizers available through the PennyLane library. The custom gradient optimizers include a vanilla gradient descent optimizer, a newton optimizer, a root mean squared propagation optimizer, a natural gradient descent optimizer, and a simultaneous perturbation stochastic approximation optimizer.

Optimizers follow different strategies to update the parameters. A significant difference is between local and global optimizers which highlights the modularity advantages of OpenQAOA in accordance with the present embodiments. Local and global optimization algorithms may employ different strategies to find the solution to nnimization/maximization problems. While a local optimizer is generally bound to a particular search space region, global optimizers try to find optimal solutions by considering much larger portions of the search space. Usually, local optimizers can find better solutions if a solution is available within the region being searched, while global optimizers are better suited to finding suitable regions.

A possible strategy to improve the optimization performances is to employ two different sets of optimizers. For example, assuming N total optimization steps for the CQL 630, one could perform the first N/2 iterations with a global optimizer (so as to identify a good region of space) and then perform the remaining N/2 steps by running a local optimizer. In OpenQAOA in accordance with the present embodiments, the user can quickly write a hybrid optimizer whose role is to stack two different optimizers. The only requirement of this hybrid optimizer is to conform to the general input/output relations of the optimizer class.

After a VQA is executed through the OpenQAOA in accordance with the present embodiments, the user receives an output 645 at the end of the CQL 630. This output is a python dictionary that contains the solution to the optimization problem. The solution is extracted from the final probability distribution of the quantum computation (note that the quantum computer returns a list of strings and the number of observations/counts of each string). The solution includes the most probable k bit strings (where k is a user-specified positive integer) and their associated probabilities/counts. The output 645 also includes a dictionary containing the mapping of the binary variables defined in the Problem Statement 602 to the result of the VQA computation. Further, the output 645 includes metadata from the classical-quantum loop 630, metadata from the backend and metadata about the SDK itself. The metadata form the CQL 630 includes the classical optimizer's 638 optimization history and the optimal set of parameters. In the case of QPUs, the metadata from the backend are the result objects provided by the hardware provider. The metadata about the SDK includes information such as the version, the time of execution, and the length of execution.

The OpenQAOA in accordance with the present embodiments can then convert the result dictionary 645 into a JSON format file 650 to simplify piping the SDK results cross-language and cross-platform (like AWS, Rigetti Quantum Cloud Services, IBM Q). The actual format of the output is given by the illustration 200 in FIG. 2. The SDK also provides a second output type, available to the user upon request in the form of metadata. This output represents the quantum circuit, which may be returned in an open quantum assembly language such as OpenQASM and allows piping the VQA within a larger quantum/classical computation. That is, the user could use OpenQAOA as a tool to optimize a specific part of their more extensive algorithm rather than using it as a stand-alone piece of software.

An advantage of having a fixed and structured output given by the header key (e.g., the Header 210) containing the indexable, searchable portion of the stored data and the data key (e.g., the Data 250) containing the raw data corresponding to an atomic result is that it implicitly allows for creating a database for VQAs. Given the cost of running computations on quantum hardware, it is of paramount importance to assign consistent and retrievable outputs to calculations performed either by different people or the same person at other times. The output standardization and a set of pre-defined helper functions that help archive the results are thus critical enabling aspects of OpenQAOA. Specifically, the ability to build a structured dataset is a fundamental aspect of OpenQAOA extensions, and is one of the essential cornerstones enabling any machine learning algorithm built for VQAs.

In addition to the functional components of the OpenQAOA process in accordance with the present embodiments, additional features and components that are not part of the core algorithmic components of OpenQAOA may be alternatively utilized (and the paths to these components are shown in FIGS. 6A, 6B, 6C and 6D as dashed lines).

Qubit Routing 660 is an algorithmic subroutine (solver) embedded into OpenQAOA and, structurally, is part of the Circuit Compilation Module 153 of the Enabler 150. Qubit Routing 660 inputs the original abstract circuit and the description of the target NISQ device (topology, gates error rates, natural gate set) and outputs a valid Abstract VQA Representation 622 which implements a logically equivalent circuit that ideally minimizes the noise during the execution on the NISQ device. Effectively, Qubit Routing 660 generates the new circuit by fitting the topological constraints of the actual hardware and finding optimal circuit equivalences to reduce the noise level of the original choices of gates. For example, reducing the number of two-qubit gates (such as SWAP gates) is a way to lower the noise introduced into the quantum computation.

Qubit Routing 660 integrates the backend-independent Abstract Representation 622 of the VQA and the CQL 630. Hence, Qubit Routing 660 outputs another VQA Abstract Representation object. By design, Qubit Routing 660 can work as a standalone software library which queries the Quantum Cloud directly to obtain extra information like the noise profiles of the quantum gates.

The Cost Management Tool (CMT) 665 is a part of the Resource Estimator and Profiling Module 155 of the Enabler 150 that profiles VQA algorithms and assesses the cost associated with running it on the available backends. The CMT 665 can estimate economic costs, time duration, and the number of circuit evaluations. The inputs of the CMT 665 are the abstract description 622 of the circuit provided by the OpenQAOA SDK and the user's backend credentials. Then, the CMT 665 will either use cached results to estimate the pricing and properties of the available Backends or directly send API requests to the different cloud providers to obtain the current availability and information.

The CMT 665, given the Abstract VQA Representation 622, returns a dataset containing a breakdown 667 of the costs for the desired combination of parameterization, optimizer, and decided backends. The available combinations can either be specified explicitly by the end-user or can be selected through some pre-set options. For example, the user may create a MaxCut Problem Statement on QAOA and ask the cost management tool 665 to return a breakdown of the costs for four different choices of optimizers against the quantum backend serviced by AWS and IMBQ. The CMT 665 will also help estimate the time required to run computations on QPUs hence allowing the user to reserve computing time accordingly.

AutoVQA 156 is a software tool that, given a particular Problem Statement 602, performs analytics to determine the best choices of parameterizations and optimizer, together with heuristics to improve the quality of the optimization result. Auto VQA 156 fundamentally mimics the work process of a user who has enough experience at prototyping VQA. A key role in prototyping is given by the statistical analysis of the Problem Statement 602. For example, properties such as the standard deviation and the distribution of the weights of the parameters in the Problem Statement may require different parameterizations choices and different optimizations strategies.

Auto VQA 156, in its basic form, receives a Problem Statement 602 as input and outputs a ranked list of built-in candidate workflows. These statistical methods are used in Auto VQA 156 in two ways: either as tree-based hard-coded rules or as machine learning models. The hard-coded rules start by computing a set of statistical properties of the problem input and proceed deterministically selecting candidate components. On the other hand, the machine learning models start using unsupervised classifiers to label the input and then proceed using supervised learning models to assign ranks to the possible combinations of parameterizations and optimizers.

Thus, it can be seen that the present embodiments provide methods, systems and kits for quantum-optimized cross-backend software development. The OpenQAOA in accordance with the present embodiments is a scalable and efficient optimization-specific SDK that is cross-platform, offers numerous parametrizations and parameter initialization strategies, provides the ability to prepend an initial state to the computation or append a state after the VQA has completed, delivers automatic and manual circuit construction (utilizing built-in workflows and workflows factory), built-in circuit compilation, VQA heuristics, resource estimation and profiling, benchmarking, error mitigation and a series of GUIs to enable improved visualization of circuits and results. In addition, the OpenQAOA in accordance with the present embodiments enables a user to quickly and seamlessly estimate costs associated with running different workflows on different backends and the functional (modular) design of OpenQAOA allows users to replace components by simply preserving the I/O relationships.

While exemplary embodiments have been presented in the foregoing detailed description of the present embodiments, it should be appreciated that a vast number of variations exist. It should further be appreciated that the exemplary embodiments are only examples, and are not intended to limit the scope, applicability, operation, or configuration of the invention in any way. Rather, the foregoing detailed description will provide those skilled in the art with a convenient road map for implementing exemplary embodiments of the invention, it being understood that various changes may be made in the function and arrangement of steps and method of operation described in the exemplary embodiments without departing from the scope of the invention as set forth in the appended claims.

1. A method for building quantum optimization algorithms that can run on quantum hardware comprising:
receiving an input comprising a user-defined problem and at least one pre-defined Variational Quantum Algorithm (VQA) statement;
converting the received input into a workflow;
obtaining an abstract Variational Quantum Algorithm (VQA) representation based on the workflow; and
creating a backend specific quantum circuit based on the abstract VQA representation and returning an output, wherein the output comprises an optimization result and additional metadata.

2. (canceled)

3. A set of tools designed to improve the usability and performances of building quantum optimization algorithms, the tools comprising:
a cost management tool to estimate costs associated with a given quantum computation wherein costs include financial costs, execution time and other metrics associated with running the given quantum computation;
AutoVQA, a system that takes the user-defined problem associated with the given quantum computation and evaluates the optimal choices of parameters for a Variational Quantum Algorithm statement of the user-defined problem; and
a qubit routing tool to compile the Variational Quantum Algorithm representation in a backend-explicit optimized quantum circuit.

4. A system for building and executing algorithms in the QAOA family, the system comprising:
an input module for obtaining an input, where the input includes a standardized version of a user-defined optimization problem and a specification of settings for the QAOA; and
a workflow module that takes as input the input model and is configured to:
convert the input into a sequence of operations defining an abstract workflow that is independent of the target device upon which the computation is to be executed;
set up and run a classical-quantum loop configured to:
create and execute the explicit representation of the quantum circuit based on the abstract QAOA representation,
optimize the parameterized variables of such a circuit, and interrupt the loop once a satisfying training condition has been met; and
return an output, the output comprising an optimization result and associated metadata.

5. The system of claim 4 wherein the input module contains a bank of common optimization problems, each of which can be called according to its standard name to reduce the user input burden.

6. The system of claim 4 wherein the input module supports the specification of a plurality of QAOA settings to subsequently allow a corresponding plurality of workflows to be created.

7. The system of claim 4 wherein the input module supports the specification of a device on which to run the computation (a ‘backend’), along with any relevant properties or characteristics of the backend.

8. The system of claim 7 wherein the workflow module contains interfaces to deploy the quantum circuits to backend devices including cloud or on-premises quantum computers, and remote or local simulators of quantum computations.

9. The system of claim 8 wherein the input module contains a bank of pre-defined QAOA computations, each of which may be called by a unique reference, for the purposes of benchmarking the performance of the available backends.

10. The system of claim 7 wherein the workflow module contains interfaces to additional modules for the purposes of qubit selection, mapping and routing.

11. The system of claim 4 wherein the workflow module contains interfaces to additional external modules for the purposes of error mitigation.

12. The system of claim 4 wherein the output of the workflow module (something specific about the results object).

13. The system of claim 4 wherein the input module supports the specification of, and the workflow module supports the use of, dynamic quantum circuit features such as mid-circuit measurements and feed-forward operations.
